(19) United States
(12) Patent Application Publication
(10) Pub. No.: US 2007/0218364 A1
(43) Pub. Date: Sep. 20, 2007

(54) LOW TEMPERATURE ELECTROCHEMICAL CELL

(76) Inventors: Jay F. Whitacre, Pittsburgh, PA (US); Rachid Yazami, Los Angeles, CA (US); Ratnakumar V. Bugga, Arcadia, CA (US); Surya G. Prakash, Hacienda Heights, CA (US); Marshall C. Smart, Studio City, CA (US); William C. West, South Pasadena, CA (US); Andre Hamwi, Clermont-Ferrand (FR)

Correspondence Address: GREENLEE WINNER AND SULLIVAN P C, 4875 PEARL EAST CIRCLE, SUITE 200, BOULDER, CO, 80301, US

(21) Appl. No.: 11/675,308

(22) Filed: Feb. 15, 2007

Related U.S. Application Data
(63) Continuation-in-part of application No. 11/253,360, filed on Oct. 18, 2005.
(63) Continuation-in-part of application No. 11/422,564, filed on Jun. 6, 2006.
(63) Continuation-in-part of application No. 11/560,570, filed on Nov. 16, 2006.
(60) Provisional application No. 60/744,262, filed on Apr. 4, 2006.
(60) Provisional application No. 60/784,957, filed on Mar. 21, 2006.
(60) Provisional application No. 60/784,960, filed on Mar. 20, 2006.
(60) Provisional application No. 60/724,084, filed on Oct. 5, 2005.
(60) Provisional application No. 60/724,084, filed on Oct. 5, 2005.
(60) Provisional application No. 60/737,186, filed on Nov. 16, 2005.
(60) Provisional application No. 60/775,110, filed on Feb. 21, 2006.
(60) Provisional application No. 60/775,559, filed on Feb. 22, 2006.
(60) Provisional application No. 60/900,409, filed on Feb. 9, 2007.
(60) Provisional application No. 60/798,532, filed on May 8, 2006.

(51) Int. Cl. H01M 4/58; H01M 4/62

(52) U.S. Cl. 429/231.7; 429/232; 429/217; 429/231.95; 429/326

(57) ABSTRACT

The present invention provides electrochemical cells providing good electronic performance at low temperatures. Electrochemical cells of the present invention include lithium batteries capable of providing useful specific capacities under significant discharge rates for temperatures as low as −60 degrees Celsius. The present invention also provides methods for making electrochemical cells including a room temperature predischarge step preceding low temperature operation that enhances the performance of batteries having subfluorinated carbonaceous positive electrode active materials at low temperatures.

### CROSS-REFERENCE TO RELATED APPLICATIONS

This application claims priority under 35 U.S.C. 119(e) to U.S. provisional Patent Application 60/774,262 filed Feb. 16, 2006, U.S. provisional Patent Application 60/784,957 filed Mar. 21, 2006, U.S. provisional Patent Application 60/784,960 filed Mar. 20, 2006, and to a U.S. provisional Patent Application filed on Feb. 9, 2007 for “Coke Based Subfluorinated Carbon Fluorides (CFx) Cathodes in Lithium Batteries” (serial number not yet assigned); this application is also a continuation-in-part of 11/253,360 and 11/422,564 filed Oct. 18, 2005 and Jun. 6, 2006, respectively, which claim the benefit of priority of U.S. Provisional Application 60/724,084 filed Oct. 5, 2005; this application is also a continuation-in-part of 11/560,570 filed Nov. 16 , 2006 which claims the benefit of priority of U.S. Provisional Application Nos. 60/737,186; 60/775,110 and 60/775,559 filed Nov. 16, 2005, Feb. 21, 2006 and Feb. 22, 2006, respectively, all of which are incorporated herein by reference in their entireties to the extent not inconsistent with the disclosure herein.

### STATEMENT REGARDING FEDERALLY SPONSORED RESEARCH OR DEVELOPMENT

The invention described herein was made in the performance of work under a NASA contract, and is subject to the provisions of Public Law 96-517 (35 U.S.C. 202) in which the Contractor has elected to retain title.

### BACKGROUND OF INVENTION

Over the last few decades revolutionary advances have been made in electrochemical storage and conversion devices expanding the capabilities of these systems in a variety of fields including portable electronic devices, air and space craft technologies, and biomedical instrumentation. Current state of the art electrochemical storage and conversion devices have designs and performance attributes that are specifically engineered to provide compatibility with a diverse range of application requirements and operating environments. For example, advanced electrochemical storage systems have been developed spanning the range from high energy density batteries exhibiting very low self discharge rates and high discharge reliability for implanted medical devices to inexpensive, light weight rechargeable batteries providing long runtimes for a wide range of portable electronic devices to high capacity batteries for military and aerospace applications capable of providing extremely high discharge rates over short time periods.

Despite the development and widespread adoption of this diverse suite of advanced electrochemical storage and conversion systems, significant pressure continues to stimulate research to expand the functionality of these systems, thereby enabling an even wider range of device applications. Large growth in the demand for high power portable electronic products, for example, has created enormous interest in developing safe, light weight primary and secondary batteries providing higher energy densities. In addition, the demand for miniaturization in the field of consumer electronics and instrumentation continues to stimulate research into novel design and material strategies for reducing the sizes, masses and form factors of high performance batteries. Further, continued development in the fields of electric vehicles and aerospace engineering has also created a need for mechanically robust, high reliability batteries capable of good device performance in a useful range of operating environments (e.g., terrestrial, lower, mid and upper atmosphere, and space).

Many recent advances in electrochemical storage and conversion technology are directly attributable to discovery and integration of new materials for battery components. Lithium battery technology, for example, continues to rapidly develop, at least in part, due to the discovery of novel electrode and electrolyte materials for these systems. From the pioneering discovery and optimization of intercalation cathode materials, such as fluorinated carbon materials and nanostructured transition metal oxides, to the development of high performance non-aqueous electrolytes, the implementation of novel materials strategies for lithium battery systems have revolutionized their design and performance capabilities. As a result of these advances, lithium battery technology is positioned to be the preferred technology for the next generation of high-power, portable electronic systems. Accordingly, the identification and performance evaluation of novel electrode and/or electrolyte materials is currently a research priority in the development of new and improved lithium based electrochemical energy storage and conversion systems.

Commercial primary lithium battery systems typically utilize a lithium metal negative electrode for generating lithium ions which during discharge are transported through a liquid phase or solid phase electrolyte and undergo intercalation reaction at a positive electrode comprising an intercalation host material. The element lithium has a unique combination of properties that make it highly attractive for use in an electrochemical cell. First, it is the lightest metal in the periodic table having an atomic mass of 6.94 AMU. Second, lithium has a very high electrochemical reduction potential (i.e., 3.045 V). This unique combination of properties enables lithium based electrochemical cells to have very high specific capacities. Essential to the development and commercial implementation of lithium batteries, however, has been the development of high performance intercalation cathode materials, and nonaqueous electrolytes capable of providing useful ionic conductivities. Useful intercalation cathode materials for lithium batteries include layered transition metal oxides (e.g., MnO₂, NiO₂, CoO₂), spinel transition metal oxides (e.g., Mn₂O₂, Ti₂O₂), transition metal sulfides (e.g. FeS₂) and fluorinated carbon materials (e.g., CF₁). Useful nonaqueous electrolytes for lithium batteries include solutions of lithium salts in polar organic or inorganic liquids, ionically conducting polymers and fused lithium salts.

Advances in materials strategies and electrochemical cell designs for lithium battery technology have realized electrochemical cells capable of providing useful device performance including: (i) high cell voltages (e.g. up to about 3 V), (ii) substantially constant (e.g., flat) discharge profiles, (iii) long shelf-life (e.g., up to 10 years), and (iv) compatibility with a range of operating temperatures (e.g., −20 to 60 degrees Celsius). As a result of these beneficial characteristics, primary lithium ion batteries are widely used as power sources in a range of portable electronic devices and in other important device applications including, biomedical engineering, sensing, military communications, and lighting. Dual intercalation lithium ion secondary batteries have also been developed. In these systems, lithium metal is replaced with an intercalation host material for the negative electrode, such as carbons (e.g., graphite, cokes etc.), metal oxides, metal nitrides and metal phosphides. State of the art lithium ion secondary batteries provide excellent charge-discharge characteristics, and thus, have also been widely adopted as power sources in portable electronic devices, such as cellular telephones and portable computers.

Given rapid advances and implementation of lithium based battery technology, these systems are currently identified as an important class of power sources for a range of aerospace applications. Target applications include electrochemical cells for satellites, spacecraft, aircraft, and defense technologies. Successful lithium battery implementation in these applications requires a combination of very high performance attributes, including high specific capacities at substantial discharge rates, good reliability and safety, and long operating lifetime. While many of these performance attributes have been demonstrated at room temperature, it is currently unclear if state of the art lithium based electrochemical systems are capable of meeting stringent performance requirements under the extreme operating conditions inherent to many of these applications, including low temperature (e.g., −30 degrees Celsius) environments.

The existing off-the-shelf suite of lithium batteries capable of providing energy at reasonable rates at these temperatures, including Li—SO₂Cl₂, Li—MnO₂, and Li—SO₂, have lingering safety issues and/or low temperature energy density values that hinder their implementation in applications requiring low temperature performance. Accordingly, there is currently a need for safe, high energy density primary batteries that can function at low temperatures (e.g., −30° C. and below) for a host of important aerospace applications.

Commercial Li/CFₓ batteries using active cathode materials consisting of fluorinated carbonaceous materials, such as coke or graphite comprise a potentially attractive system for low temperature energy source applications. Many of these systems utilize nonaqueous electrolyte solutions having low freezing points that are compatible with low temperature operation. Further, Li/CFₓ battery systems are know to be capable of delivery of up to 700 Wh/kg, 1000 Wh/l, at room temperature, and at a rate of C/100 (i.e., a battery current of a 1/100^{th} that of the capacity of the battery per hour). (See, e.g., Bruce, G. Development of a CFx D Cell for Man Portable Applications. in Joint Service Power Expo. 2005; and Gabano, J. P., ed. Lithium Batteries, by M. Fukuda & T. lijima. 1983, Academic Press: New York). Cathodes in these systems typically have carbon—fluoride stoichiometries typically ranging from CF_{1.05} to CF_{1.1}. This cathode material, however, is known to be discharge rate limited, and currents lower than C/50 (battery current 1/50^{th} that of the capacity of the battery divided by 1 hour) are often necessary to avoid cell polarization and large capacity loss. Low electronic conductivity of CFx is a potential cause of the observed discharge rate limitations, as there is a strong correlation between cathode thickness and performance; thicker cathodes tend to be more rate-limited. (See, e.g., Gunther, R. G. in Fifth Power Sources Conference. Pages 713-728, 1975).

To address discharge rate limitations, a number of high performance Li—CFₓ batteries have been designed using thin cathode structures in a spirally-wound configuration. This development has provided some promising results both at room temperature and low temperature operating conditions. For example, a 15.5 Ah fully packaged D cell has been reported that delivers over 460 Wh/kg at better than a C/8 rate at room temperature, and that delivers about 12 Ah under a 2 A discharge, with an active cathode materials utilization of over 570 mAh/g at −20° F. (−29° C.). (See, e.g., Bruce, G. Development of a CFx D Cell for Man Portable Applications. in Joint Service Power Expo. 2005.). A similar CFx spirally-wound electrode design exhibited a bulk cathode impedance of 0.0002 ohms/mm² and was able to deliver over 500 mAh/g active cathode material at a C/20 rate at −30° C. (See, e.g., T. Tan, P. Lam, and H. Yumoto. Li/(CF)n Battery for Low Temperature and High Power Application. in 208th Electrochemical Society Meeting. 2005. Los Angeles, Calif.) Substantial self heating under some discharge conditions has also been reported for the Li—CFx positive electrode system, which could also enhance low temperature operation of these electrochemical cells. (See, e.g., Rohde, D., M. J. Root, and D. Fostor. Li/CFx Cell and Material Development for High Rate Applications. in 37th Power Sources Conference. 1996

As will be clear from the foregoing, there exists a need in the art for electrochemical storage and conversion devices capable of satisfying the demanding device performance requirements inherent to many important aerospace applications. Specifically, electrochemical cells are needed that are capable of providing useful specific capacities under large discharge rate conditions and at low temperatures (e.g., less than about −30 degrees Celsius). A need exists for new electrode and electrolyte materials for primary and secondary lithium batteries that enhance system performance at low temperature.

### SUMMARY OF THE INVENTION

The present invention provides electrochemical cells providing good electronic performance, particularly at low temperatures. Electrochemical cells of the present invention include lithium batteries with useful specific capacities under significant discharge rates for a wide range of temperatures, including temperatures as low as about −60 degrees Celsius. The present invention also provides methods for making electrochemical cells including a room temperature predischarge step that enhances the performance of batteries having subfluorinated carbonaceous positive electrode active materials at low temperatures.

Electrochemical cells of the present invention combine specially selected electrode and electrolyte materials, compositions and form factors to provide higher specific capacities than conventional state of the art electrochemical cells for substantial discharge rates (e.g., greater than or equal to about C/20) over a wide range of temperatures, including temperatures less than or equal to about −20 degrees Celsius. Electrochemical cells of the present invention include lithium batteries having a positive electrode comprising a multiphase, subfluorinated carbonaceous active material that are capable of providing high specific capacities (e.g., specific capacity greater than or equal to about 625 mAh g⁻¹) for high current density discharge conditions over a wide range of temperatures. The present invention also provides electrolyte compositions for lithium batteries providing high ionic conductivities, good chemical stability and useful positive electrode wetting an conditioning characteristics during low temperature operation.

In an aspect, the present invention provides novel materials strategies for enhancing the performance of lithium batteries. For example, the present invention provides complementary subfluorinated carbonaceous positive electrode active materials and electrolyte compositions that provide synergistic performance enhancements important for improving the electronic performance of lithium batteries at low temperatures and/or for accessing advantageous electrode form factors, including thicker positive electrode configurations. In an embodiment, for example, the present invention provides subfluorinated carbonaceous positive electrode active materials comprising nanoscale intermixed fluorinated and unfluorinated domains providing enhanced cathode performance at low temperatures compared to conventional CF₁ positive electrode active materials. The present invention also provides electrolyte compositions for lithium ion batteriess, including anion receptor additives, lithium salt concentrations, and nonaqueous solvent compositions, providing physical and chemical properties that extend the range of useful operating temperatures of electrochemical cells having subfluorinated carbonaceous positive electrode active materials. The combination of subfluorinated positive electrode active materials and electrolyte compositions of the present invention enhance the kinetics and charge transfer properties of the positive electrode and the ion conductivity of the electrolyte, thereby enabling lithium batteries exhibiting superior low temperature performance compared to state of the art lithium battery systems and enabling electrochemical cells having advantageous positive electrode form factors and configurations.

In an aspect, the present invention provides an electrochemical cell capable of low temperature operation having a positive electrode comprising a multiphase subfluorinated carbonaceous active material. In an embodiment, an electrochemical cell of this aspect comprises a positive electrode comprising a subfluorinated carbonaceous material having an average stoichiometry CFx, wherein x is the average atomic ratio of fluorine atoms to carbon atoms and is selected from the range of about 0.3 to about 1.0. The subfluorinated carbonaceous material comprising the positive electrode of this aspect of the present invention is a multiphase material having an unfluorinated carbon component and at least one fluorinated carbon component. An electrochemical cell of this embodiment further comprises a negative electrode; and a nonaqueous electrolyte that is provided between the positive and negative electrodes. Useful negative electrodes in electrochemical cells of this aspect of the present invention comprise a source of metal cations, such as lithium ions. Nonaqueous electrolytes are preferably provided such that ions in the electrolyte can efficiently interact with positive and negative electrodes of the electrochemical cell. Optionally, the electrolyte of this aspect comprises a high performance low temperature electrolyte having a composition selected to provide ionic conductivities and reaction kinetics at the subfluorinated carbonaceous positive electrode for enhanced low temperature performance.

As used herein, the expression “subfluorinated carbonaceous material” refers to a multiphase carbonaceous material having an unfluorinated carbonaceous component. As used herein an “unfluorinated carbonaceous component” includes unfluorinated carbon compositions and/or phases, such as graphite, coke, multiwalled carbon nanotubes, carbon nanofibers, carbon nanowhiskers, multi-layered carbon nanoparticles, carbon nanowhiskers, and carbon nanorods, and also includes slightly fluorinated carbon compositions and/or phases. Slightly fluorinated, in this context, refers to carbon that is weakly bound to fluorine, as opposed to compositions wherein carbon is covalently bonded to fluorine, as in CF₁ and C₂F phases. Multiphase subfluorinated carbonaceous materials may comprises a mixture of carbonaceous phases including, one or more unfluorinated carbonaceous phases, and one or more fluorinated phase (e.g., poly(carbon monoflouride (CF₁); poly(dicarbon monofluoride) etc.). Subfluorinated carbonaceous materials include carbonaceous materials exposed to a fluorine source under conditions resulting in incomplete or partial fluorination of a carbonaceous starting material. Subfluorinated carbonaceous materials useful in the present invention and related methods of making subfluorinated carbonaceous materials are described in U.S. patent application Ser. Nos. 11/253,360, 11/422,564 and 11/560,570 filed Oct. 18, 2005, Jun. 6, 2006, and Nov. 16 , 2006, respectively, which are hereby incorporated by reference in their entirety to the extent not inconsistent with the present description.

Selection of the fluorine atom to carbon atom stoichiometry of the subfluorinated carbonaceous positive electrode active material in this aspect of the invention determines, at least in part, the specific capacity and discharge rate characteristics of the electrochemical cell, wherein a larger extent of fluorination (e.g. a larger value of x) provides for larger specific capacities. In some embodiments, for example, selection of a large average atomic ratio (x) of fluorine atoms to carbon atoms, for example x equal to about 0.5 to about 0.9, is useful for providing electrochemical cells capable of exhibiting specific capacities greater than about 500 mAh g⁻¹ for discharge at about 2 V, and in some embodiments greater than about 625 mAh g⁻¹ for discharge at about 2.1 V. The fluorine atom to carbon atom stoichiometry also, at least in part, determines the extent of the unfluorinated component of the subfluorinated carbonaceous positive electrode active material. In some embodiments, the unfluorinated carbon component is between about 5% to about 70% by mass of the subfluorinated carbonaceous material comprising the positive electrode active material, and preferably for some embodiments the unfluorinated carbon component is between about 10% to about 20% by mass of the subfluorinated carbonaceous material comprising the positive electrode active material. Use of subfluorinated carbonaceous positive electrode active materials having an unfluorinated carbon component of at least about 5% by mass is beneficial for providing electrodes having useful conductivities in some embodiments.

A range of carbonaceous materials are useful for subfluorinated active materials in positive electrodes of the present invention including graphite, coke, and carbonaceous nanomaterials, such as multiwalled carbon nanotubes, carbon nanofibers, multi-layered carbon nanoparticles, carbon nanowhiskers and carbon nanorods. In an embodiment, the subfluorinated carbonaceous material comprises a plurality of nanostructured particles; wherein each of the nanostructured particles comprise a plurality of fluorinated domains and a plurality of unfluorinated domains. In the context of this description a “domain” is a structural component of a material having a characteristic composition (e.g., unfluorinated or fluorinated), phase (e.g., amorphous, crystalline, C₂F, CF₁, graphite, coke, carbon fiber, carbon nanomaterials such as multiwalled carbon nanotube, carbon whisker, carbon fiber etc.), and/or morphology. Useful subfluorinated carbonaceous materials for positive electrode active materials comprise a plurality of different domains. Individual fluorinated and unfluorinated domains preferably for some applications have at least one physical dimension (e.g., lengths, depths, cross sectional dimensions etc.) less than about 50 nanometers, and more preferably for some applications at least one physical dimension less than about 10 nanometers. Positive electrode active materials particularly useful for electrochemical cells providing high performance at low temperatures include nanostructured particles having fluorinated domains and unfluorinated domains that are distributed throughout each nanostructured particle of the active material, and in some embodiments substantially uniformly distributed throughout each nanostructured particle of the active material. In some embodiments, fluorinated domains of particles of the positive electrode active material comprise a subfluorinated carbonaceous material having an average stoichiometry CFy, wherein y is the average atomic ratio of fluorine atoms to carbon atoms and is selected from the range of about 0.8 to about 0.9, and the unfluorinated domains of the particles of the positive electrode active material comprise a unfluorinated carbonaceous phase, such as graphite, coke, multiwalled carbon nanotubes, multi-layered carbon nanofibers, multi-layered carbon nanoparticles, carbon nanowhiskers and carbon nanorods.

Use of nanostructured subfluorinated carbonaceous particles as positive electrode active materials provides a number of benefits in electrochemical cells of the present invention. First, nanoscale intermixing of fluorinated and unfluorinated domains in these particles results in high interfacial surface areas between the fluorinated and unfluorinated domains. This attribute provides good electronic and interface properties between these domains facilitating electron transfer, particularly at low temperatures. In addition, the presence of an appreciable unfluorinated component in these particles enhances net electrode conductivity by providing nanoscale electrically conducting pathways in the electrode active material. Further, the distribution of nanoscale fluorinated domains in these materials provides an appreciable density of fluorinated domains having high fluorine ion loading exposed to the electrolyte, thereby resulting in a high interfacial surface area of fluorinated structural domains exposed to the electrolyte further enhancing the kinetics at the positive electrode.

Positive electrodes of the present electrochemical cell may further comprises a conductive diluent, such as acetylene black, carbon black, powdered graphite, coke, carbon fiber, and metallic powder, and/or may further comprises a binder, such polymer binder. Useful binders for positive electrodes in some embodiments comprise a fluoropolymer such as polyvinylidene fluoride (PVDF). Positive electrodes of the present invention may be provided in a range of useful configurations and form factors as known in the art of electrochemistry and battery science, including thin electrode designs, such as thin film electrode configurations. In an embodiment, the positive electrode comprises a thin composite film comprising a subfluorinated carbonaceous active material provided on metallic current collector, wherein the thickness of the thin composite film is selected from the range of about 20 microns to 120 microns. Electrode active materials and electrolytes of the present invention enable lithium batteries capable of providing useful discharge rates with electrode form factors having thicknesses greater than or equal to about 90 microns. In an embodiment, a positive electrode comprising a subfluorinated carbonaceous active material is provided in a spirally-wound electrode configuration.

Negative electrodes of the present invention comprise a source of ions of a metal selected from Groups 1, 2, and 3 of the Periodic Table of Elements. In embodiments of the present invention comprising a low temperature lithium battery the negative electrode comprises a source of lithium ions, such as lithium metal, a lithium alloy, a carbon-lithium material and lithium metal oxide intercalation compounds. Useful carbon-lithium materials include carbonaceous materials, such as graphite or coke, intercalated with lithium ions.

In another aspect, electrochemical cells of the present invention have a nonaqueous electrolyte comprising a high performance low temperature electrolyte. In the context of this description, the expression “high performance low temperature electrolyte” refers to electrolyte compositions having a low freezing point and one or more of the following properties at temperatures less than about −20 degrees Celsius: (i) ionic conductivity of greater than or equal to 0.0001 S cm⁻¹, greater than or equal to 0.001 S cm⁻¹, or greater than or equal to 0.005 S cm⁻¹; (ii) good positive electrode conditioning and wetting properties for subfluorinated carbonaceous electrode active materials; and (iii) high chemical and electrochemical stability, particularly with respect to decomposition on positive and negative electrode surfaces. The present invention provides a range of high performance low temperature electrolytes having physical and chemical properties that enhance the low temperature performance of electrochemical cells having subfluorinated carbonaceous positive electrode active materials.

In an embodiment, a high performance low temperature nonaqueous electrolyte comprises a solution of a lithium salt and a solvent. Useful lithium salts for this aspect of the present invention include, but are not limited to, LiBF₄, LiF, LiClO₄, LiAsF₆, LiSbF₆ and LiPF₆. The concentration of lithium salt in the nonaqueous electrolyte solution is an important parameter which is selected in some embodiments to enhance low temperature performance. In an embodiment, for example, the lithium salt, such as LiBF₄, has a concentration in the nonaqueous electrolyte solution that is preferably less than 1.0 M for some applications, and more preferably less than 0.5 M for some applications. Useful lithium salt concentrations for some electrochemical cells of the present invention are selected from the range of about 0.75 M to about 0.25 M, for example when LiBF₄ is the selected lithium salt.

Solvent composition is also selected in embodiments of the present invention to enhance low temperature electrochemical cell performance. Solvents useful in nonaqueous electrolytes of the present invention include, but are not limited to, propylene carbonate, 1,2-dimethoxy ethane, trifluoroethyl ether, diethyl ether, diethoxyethane, 1-3 dioxolane, tetrahydrofuran, 2-methyl tetrahydrofuran, ethylene carbonate, dimethyl carbonate, diethyl carbonate, ethyl methyl carbonate, methyl formate, α-butyrolactone, dimethyl carbonate, diethyl carbonate, methyl ethyl carbonate, gamma-butyrolactone, diethoxyethane, acetonitrile, and methylacetate. Nonaqueous electrolytes of the present invention also include fluorine analogs of the solvents provided above. In the context of this description fluorine analogs include: (i) fully fluorinated analogs wherein each hydrogen atom of the solvent molecule is replaced by a fluorine atom, and (ii) partially fluorinated analogs wherein at least one hydrogen atom of the solvent molecule is replaced by a fluorine atom. Use of solvents containing fluorine analogs is preferred in some embodiments as these materials comprise a fluorous phase that can associatively interact with the positive electrode given the inherent fluorophilicity of subfluorinated and fully fluorinated carbonaceous electrode active materials. For example, fluorophilic subflourinated CFx active material undergo enhance wetting and conditioning at the positive electrode, thereby enabling high discharge rate performance, particularly at low temperatures.

Use of a solvent comprising a mixture of mixture of propylene carbonate (or alternatively ethylene carbonate) and 1,2-dimethoxy ethane provides a nonaqueous electrolyte solution exhibiting useful physical and chemical properties in the present invention. The relative proportions of propylene carbonate and 1,2-dimethoxy ethane in these solvent blends is selected to provide sufficient propylene carbonate to achieve a high dielectric constant so as to prevent significant self discharge, thereby enhancing battery stability. In some embodiments sufficient 1,2-dimethoxy ethane is provided in the electrolyte to achieve low viscosity and good coordinating properties with the lithium salt so as to provide useful ionic conductivities. In addition, propylene carbonate should be provided in sufficient proportion so as to impart effective passivation of the negative electrode. In an embodiment, for example, the solvent has a volume to volume ratio of propylene carbonate to 1,2-dimethoxy ethane is selected from the range of about 0.25 to about 1. In an embodiment, for example, the solvent has a volume to volume ratio of propylene carbonate to 1,2-dimethoxy ethane that is less than about 0.50.

Another strategy for enhancing the low temperature performance of nonaqueous electrolytes in electrochemical cells of the present invention includes use of solvents containing an ether having at least one fluroalkyl group, such as trifluoroethyl ether (TEE). Ethers having fluoroalkyl groups impart beneficial physical properties to electrolyte solutions of the present invention due to the low melting points, low viscosity and good solvating properties of these compounds. Further, addition of hydrofluorocarbon ethers to the electrolyte solution enhances the wetting of active electrode materials comprising subfluorinated carbonaceous materials. In an embodiment, the invention provides a nonaqueous electrolyte solution comprising an ether having at least one fluroalkyl group, such as trifluoroethyl ether, having a percent by volume of the solvent selected from the range of about 10% to about 40%. As described above, use of electrolyte materials comprising a fluorous phase (i.e., ethers having one or more fluoroalkyl groups) enhances wetting and/or conditioning of fluorophilic electrode active materials, such as subfluorinated carbonaceous materials.

In another aspect, the present invention provides high performance nonaqueous electrolyte solutions comprising an anion receptor. High performance nonaqueous electrolytes of the present invention are particularly beneficial for enhancing low temperature performance of lithium batteries having a fluorinated carbonaceous positive electrode active material, such as a subfluorinated carbonaceous material or fully fluorinate carbonaceous material. Incorporation of anion receptors that do not use hydrogen bonding to tie up the anion, such as a Lewis acid anion receptor, increases the solubility of the lithium salt so as to enhance the net ionic conductivity of the electrolyte solutions of the present invention, particularly at low temperatures. Incorporation of anion receptor also improves performance of the present high performance low temperature electrolytes by conditioning the positive electrode active material. In an embodiment, for example, anion receptors of the present invention are capable of dissolving discharge reactants that can buildup on the positive electrode surface upon discharge of the electrochemical cell. Dissolution of such discharge reactants is beneficial as buildup can reduce kinetic performance at the electrode, particularly at the positive electrode. Dissolution of discharge reactants by anion receptors in nonaqueous electroytes of electrochemical cells of the present invention enables the practical thickness of the active material positive electrode to be increased while still preserving useful discharge rate performance. (e.g., high discharge rate capability, no significant voltage delay or severe polarization effects).

In an embodiment, a high performance nonaqueous electrolyte of the present invention further comprises an anion receptor capable of coordinating fluoride ions. Use of a fluoride ion anion receptor in these aspects of the present invention is useful for reducing or eliminating unwanted LiF buildup on the positive electrode interface. During discharge of a lithium battery, LiF commonly precipitates on the surface of carbonaceous positive electrode active materials. LiF is virtually insoluble in many nonaqueous electrolytes and is also electrochemically inactive. Therefore, build up on an electrode surface impedes ionic and/or electronic conductivity at the positive electrode. Further, the equilibrium constant (Kₛₚ) for the LiF precipitation reaction is small;
Li⁺ₛₒₗₙ+F⁻ₛₒₗₙ [symbol] LiFₚₚₜ;
thereby strongly favoring the formation of the solid precipitate LiFₚₚₜ at the surface of the positive electrode. Moreover, LiFₚₚₜ grain growth via Ostwald ripening is exceeding slow resulting in tiny grains that do not grow effectively, but rather agglomerate, thereby resulting in a dense fine coating at the cathode capable of degrading electron and ion conductivity.

Addition of a fluoride ion anion receptor in the electrolytes of the present invention is useful for initiating the dissolution of LiFₚₚₜ via a fluoride ion complex reactions. By removing the buildup of LiFₚₚₜ during discharge, the high performance low temperature electrolytes of the present invention enhance electronic conductivity by improving electrolyte access to the carbonaceous positive electrode active material. Furthermore, after LiF saturates in the nonaqueous electrolyte solution, grain growth of the LiFₚₚₜ is much more favored, resulting in less conformal coating of the positive electrode. A beneficial result provided by the addition of fluoride ion anion receptors of the present invention is to modify the composition and/or morphology of the solid electrolyte interface (SEI) film so as to decrease interfacial resistance at the subfluorinated carbonaceous positive electrode.

Useful anion receptors in the present high performance nonaqueous electrolyte solutions include fluorinated boron-based anion receptors, such as boranes, boronates and borates having electron withdrawing ligands. Useful anion receptors in the electrochemical cells of the present invention include, but are not limited to, fluorinated borate-based compounds, phenyl boron-based compounds and aza-ether boron-based compounds. Anion receptor-containing nonaqueous electrolyte solutions of some aspects of the present invention have a concentration of anion receptor less than about 2 M, preferably for some embodiments a concentration of anion receptor less than about 1 M, and more preferably for some embodiments a concentration of anion receptor less than about 0.5 M.

In some embodiments, anion receptors of the present invention are capable of facilitating dissolution of low solubility lithium salts, such as LiF, in a non aqueous solvent. Anion receptors of the present invention are capable of increasing the specific capacity of subfluorinated carbonaceous positive electrodes. Anion receptors of the present invention are capable of increasing the conductivity of nonaqueous electrolyte solutions of the present invention, for example, to a value greater than or equal to about 0.001 S cm⁻¹ for some embodiments or, a value greater than or equal to about 0.01 S cm⁻¹ for some embodiments.

A high performance low temperature nonaqueous electrolyte solution of the present invention further comprises an anion receptor having the chemical structure AR1: 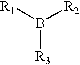
wherein R₁, R₂ and R₃ are independently selected from the group consisting of alkyl, aromatic, ether, thioether, heterocyclic, aryl or heteroaryl groups which are optionally substituted with one or more halogens, including F, alkyl, alkoxide, thiol, thioalkoxide, aromatic, ether or thioether.

In a specific embodiment, for example, the present invention provides a high performance low temperature nonaqueous electrolyte solution comprising a borate-based anion receptor compound having the chemical structure AR2: 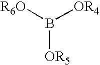
wherein R₄, R₅ and R₆ are selected from the group consisting of alkyl, aromatic, heterocyclic, aryl or heteroaryl groups which are optionally substituted with one or more halogens, including F, alkyl, alkoxide, thiol, thioalkoxide, aromatic, ether or thioether. In an embodiment R₄, R₅ and R₆ are identical. In an embodiment, each of R₄, R₅ and R₆ are F-bearing moieties.

In a specific embodiment, for example, the present invention provides a high performance low temperature nonaqueous electrolyte solution comprising a phenyl boron-based anion receptor compound having the chemical structure AR3: 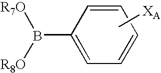
wherein R₇ and R₈ are selected from the group consisting of alkyl, aromatic, heterocyclic, aryl or heteroaryl groups which are optionally substituted with one or more halogens, including F, alkyl, alkoxide, thiol, thioalkoxide, aromatic, ether or thioether. In an embodiment R₇ and R₈ are identical. In an embodiment, each of R₇ and R₈ are F-bearing moieties. In an embodiment, R₇ and R₈ together from an aromatic, including a phenyl that is optionally substituted, including substituents that are F and substituents that are themselves F-bearing moieties, as shown by chemical formula AR4: 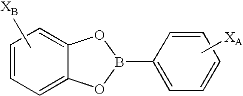
wherein X_{A} and X_{B} represent one or more hydrogens or non-hydrogen ring substituents independently selected from the group consisting of halogens, including F, alkyl, alkoxide, thiol, thioalkoxide, ether, thioether. In an embodiment, at least one of the substituents is a F-bearing moiety.

A high performance low temperature nonaqueous electrolyte solution of the present invention further comprises a Tris (hexafluoroisopropyl) borate (THFIB; MW=511.9 AMU) anion receptor having the chemical structure AR5: 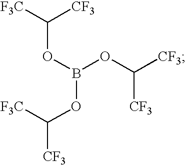
or a Tris (2,2,2-trifluoroethyl) borate (TTFEB; MW=307.9 AMU) anion receptor having the chemical structure AR6: 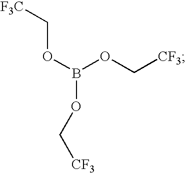
or a Tris (pentafluorophenyl) borate (TPFPB; MW=511.98 AMU) anion receptor having the chemical structure AR7: 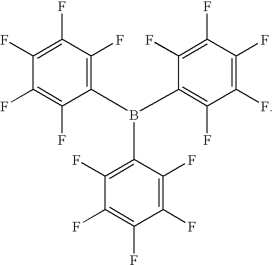
or a Bis (1,1,3,3,3-hexafluoroisopropyl) pentafluorophenyl boronate (BHFIPFPB; MW−480.8 AMU) anion receptor having the structure AR8:

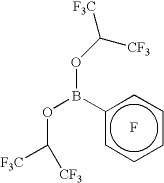

Anion receptors useful in electrolytes of present invention include those having the formula selected from the group consisting of: (CH₃O)₃B, (CF₃CH₂O)₃B, (C₃F₇CH₂O)₃B, [(CF₃)₂CHO]₃B, [(CF₃)₂C(C₆H₅)O]₃B, ((CF₃)CO)₃B, (C₆H₅O)₃B, (FC₆H₄O)₃B, (F₂C₆H₃O)₃B, (F₄C₆HO)₃B, (C₆F₅O)₃B, (CF₃C₆H₄O)₃B, [(CF₃)₂C₆H₃O]₃B and (C₆F₅)₃B.

The present invention provides lithium batteries capable of enhanced operation, particularly at low temperatures. A primary lithium battery of the present invention is capable of providing discharge rates equal to or greater than C/5 at temperatures lower than or equal to −40 degrees Celsius; wherein C is the capacity of the electrochemical cell. A primary lithium battery of the present invention is capable of providing a specific capacity equal to or greater than 500 mAh g⁻¹ at a discharge rate of C/5 and with a discharge voltage greater than or equal to about 2.5 V at a temperature equal to −40 degrees Celsius. A primary lithium battery of the present invention is capable of providing a specific capacity of 625 mAh/g for discharge at C/40 at −40 C at 2.3V. A primary lithium battery of the present invention is capable of providing an energy density greater than or equal to about 1700 Wh kg⁻¹, at a discharge rate equal to or greater than about C/40 and at −40 degrees Celsius.

In another aspect, the present invention provides a method of generating an electrical current at a temperature less than or equal to −40 degrees Celsius comprising the steps of: (i) providing an electrochemical cell comprising: a positive electrode comprising a subfluorinated carbonaceous material having an average stoichiometry CFₓ, wherein x is the average atomic ratio of fluorine atoms to carbon atoms and is selected from the range of about 0.3 to about 1.0; the subfluorinated carbonaceous material being a multiphase material having an unfluorinated carbon component; a negative electrode; and a nonaqueous electrolyte provided between the positive and negative electrodes; and (ii) discharging the electrochemical cell at a temperature less than or equal to −40 degrees Celsius. Optionally, the method of this aspect of the invention further comprising the step of discharging a portion of the capacity of the electrochemical cell at a temperature equal to about 20 to about 30 degrees Celsius prior to the step of discharging the electrochemical cell at a temperature less than or equal to −40 degrees Celsius. In an embodiment, for example, between about 0.5% to about 10% of the capacity of the electrochemical cell is discharged at a temperature equal to about 20 to about 30 degrees Celsius prior to the step of discharging the electrochemical cell at a temperature less than or equal to −40 degrees Celsius.

In another aspect, the present invention provides a method of making an electrochemical cell capable of low temperature operation comprising the steps of: (i) providing an electrochemical cell comprising: a positive electrode comprising a subfluorinated carbonaceous material having an average stoichiometry CFₓ, wherein x is the average atomic ratio of fluorine atoms to carbon atoms and is selected from the range of about 0.3 to about 1.0; the subfluorinated carbonaceous material being a multiphase material having an unfluorinated carbon component; a negative electrode; and a nonaqueous electrolyte provided between the positive and negative electrodes; and discharging a portion of the capacity of the electrochemical cell at a temperature equal to about 20 to about 30 degrees Celsius. In an embodiment of this aspect of the invention, between about 0.5 % to about 10% of the capacity of the electrochemical cell is discharged at a temperature equal to about 20 to about 30 degrees Celsius prior to the step of discharging the electrochemical cell at a temperature less than or equal to−40 degrees Celsius.

Use of a room temperature predischarge step are useful in these methods of the present invention for achieving optimal low temperature performance, including high specific capacities and stable discharge characteristics (e.g., reduced voltage delay, enhanced discharge stability). In some embodiments, room temperature predischarge conditioning results in formation of a fluorine-free carbonaceous layer at the positive electrode—electrolyte interface that enhances wetability and conductivity of the electrode. Room temperature predischarge conditioning provides a useful means, therefore, of preparing the positive electrode interfacial regions to accommodate high performance low temperature discharge.

Without wishing to be bound by any particular theory, there can be discussion herein of beliefs or understandings of underlying principles relating to the invention. It is recognized that regardless of the ultimate correctness of any mechanistic explanation or hypothesis, an embodiment of the invention can nonetheless be operative and useful.

### BRIEF DESCRIPTION OF THE DRAWINGS

FIG. 1. X-ray diffraction patterns (CuK_{α}radiation) from the two different SFCFₓ materials studied.

FIG. 2. Scanning electron micrograph of pure CF_{0.54} material dispersed on an Al sample holder.

FIG. 3. SEM/XEDS mapping of CF_{0.54} material.

FIG. 4. Line scan x-ray energy dispersive data showing the relative normalized intensities of the ka x-rays excited as a function of position (as indicated by line on SEM image).

FIG. 5. Discharge profiles of CF_{0.54} cathodes at room temperature at 2 C and C/5 rates. These cathodes were approximately 1 millimeter in thickness, and contained 80 wt % CF_{0.54}.

FIG. 6. Discharge data from cathodes made with a mix of a high-mass fraction schwanagan black and commercially fabricated CF_{1.08} at C/5 and 2 C discharge rates (data from the CF_{0.54} materials are shown for comparison). The overall C/F ratio in these composite cathodes was similar as those in the CF_{0.54} cathode mix.

FIG. 7. Room-temperature data from a Li—CF_{0.65} test cell. The cathodes were about 1.5 mils thick. Discharge rates were C/5 and 2 C.

FIG. 8. Performance of the cathodes based on commercial CF_{1.08} material mixed with 30 wt % carbon black. The electrolyte solvent was 20/80 wt % PC/DME, the discharge temperature was −40° C., the active material mass was 6.08, 4.64 mg for the C/20, C/40 cells (respectively), and the cathode thickness: <1 millimeter.

FIG. 9. Discharge data from similar Li—CF_{0.65} test cells at −40° C. with and without a room-temperature pre-discharge of 3% the total capacity of the cell.

FIG. 10. Discharge data from test cells at −40° C. as discharged at different rates. (a) CF_{0.65} test cell discharged at a C/20 rate followed by a C/40 rate. (b) CF_{0.65} test cell discharged at a C/10 rate Followed by a C/20 rate. (c) Li—CF_{0.54} test cell at a C/10 rate followed by a C/20 rate at −40° C.

FIG. 11. Potential vs. time plots for room temperature and −40° C. galvanostatic testing on Li/Cu half cells. The current used, 0.23 mA, was a typical discharge rate for the Li—CFₓ cells.

FIG. 12. Three-electrode measurements using a Li reference electrode on a Li—CF_{1.08} glass test cell. The scale for the anode potential is on the right.

FIG. 13. Electrochemical impedance spectroscopy data from the cathode side of a three electrode Li—CF^{1.08} test cell before and after a two hour room temperature conditioning discharge.

FIG. 14. Discharge data from Li—CF_{0.65} test cells at −40° C. at a C/10 rate. Five different electrolytes are compared here. The two cells that offered very little capacity at this discharge rate were then discharged at a C/40 rate and subsequently yielded full capacity.

FIG. 15. EIS data collected from Li—CF0.65 cells before and after full discharge at −40° C. with 8/2 v/v % DME/PC electrolyte solvent using (a) 1 M LiBF₄ and (b) 0.5 M LiBF₄. The frequency range was 100,000 Hz to 50 mHz.

FIG. 16. Discharge data from various Li—CFₓ test cells at −40° C. at a C/5 rate. The cells containing SFCFₓ yielded significantly more capacity at higher discharge potentials than that for the cell containing commercially available CF_{1.08}. The Highest capacity material was CF_{0.82} (MWNT precursor), which delivered over 650 mAh/g above 1.5V.

FIG. 17. Discharge behavior at a C/5 rate, −40 degrees C as a function of composite cathode thickness, for CF_{0.65}-based test cells. The 0.5 M LiBF₄ with 8/2 v/v % DME/PC electrolyte was used in all cases, and the TTFEB anion acceptor was added in thick electrode case (115 μm thick).

FIG. 18. The high rate, low temperature performance of LiCF^{0.65} cells with anion receptor added to the 0.5 M LiBF₄ with 8/2 v/v % DME/PC electrolyte. At −60° C., over 250 mAh/g was delivered at a C/5 rate. The composite cathode structures were approximately 40 μm thick for these tests.

FIG. 19. Capacity yielded at −40° C. from SFCFₓ test cells based on either graphitic or MWNT precursor material. A C/10 discharge was used in all cases.

FIG. 20. Discharge data from test cells at −40° C. as discharged at different rates. (a) CF_{0.65} test cell discharged at a C/20 rate followed by a C/40 rate. (b) CF_{0.65} test cell discharged at a C/10 rate Followed by a C/20 rate. (c) Li—CF_{0.54} test cell at a C/10 rate followed by a C/20 rate at −40° C.

FIG. 21. CF_{0.65} and CF_{1.08} cathode materials as discharged under C/10 and C/5 rates. The CF_{1.08} baseline material yielded a specific capacity less than 30% of the CF_{0.65} material.

FIG. 22. Specific capacity as a function of fluorination level in the sub-fluorinated CFx materials as discharged at a C/10 rate at −40 degrees C.

FIG. 23. Discharge behavior at a C/5 rate, −40 degrees C as a function of composite cathode thickness, for CF_{0.65}—based test cells.

FIG. 24. The effects of the anion receptor additive on the performance of CF_{0.65}—bases test cells. C/2.5 discharge rates were possible using this new electrolyte blend.

FIG. 25. The performance of CF_{1.08}—based cathodes under identical conditions (C/2.5 rate, −40° C.) using the same electrolyte +anion receptor. Nearly an order of magnitude less specific capacity was realized. Cell B discharge was stopped after 30 mAh/g and a lower rate discharge was attempted.

FIG. 26. Li—CF_{0.65} test cells with the anion receptor additive at −40, −50, and −60 degrees C at a C/5 discharge rate. Even at −60 C, a specific capacity of nearly 300 mAh/g was realized.

FIG. 27. A thick electrode CF_{0.65} discharge with anion receptor additive: a functional, high rate (C/5) cathode 115 microns thick was created and offered nearly 600 mAh/g.

FIG. 28A provides plots of the imaginary impedance (Ohms) versus real impedance (Ohms) for a propylene carbonate solution having a varying lithium salt and anion receptor composition. FIG. 28B shows these plots on an expanded scale for the circled region indicated in FIG. 28A.

FIG. 29 provides plots showing the results of cyclic voltammetry experiments which show the reductive stability of a tris (hexafluoroisopropyl) borate anion receptor in a propylene carbonate solvent.

### DETAILED DESCRIPTION OF THE INVENTION

Referring to the drawings, like numerals indicate like elements and the same number appearing in more than one drawing refers to the same element. In addition, hereinafter, the following definitions apply:

The term “electrochemical cell” refers to devices and/or device components that convert chemical energy into electrical energy or electrical energy into chemical energy. Electrochemical cells typical have two or more electrodes (e.g., positive and negative electrodes) wherein electrode reactions occurring at the electrode surfaces result in charge transfer processes. Electrochemical cells include, but are not limited to, primary batteries, secondary batteries, lithium batteries and lithium ion batteries. General cell and/or battery construction is known in the art, see e.g., U.S. Pat. Nos. 6,489,055, 4,052,539, 6,306,540, Seel and Dahn J. Electrochem. Soc. 147(3) 892-898 (2000).

The term “capacity” is a characteristic of an electrochemical cell that refers to the total amount of electrical charge an electrochemical cell, such as a battery, is able to hold. Capacity is typically expressed in units of ampere-hours. The term “specific capacity” refers to the capacity output of an electrochemical cell, such as a battery, per unit weight. Specific capacity is typically expressed in units of ampere-hours kg⁻¹.

The term “discharge rate” refers to the current at which an electrochemical cell is discharged. Discharge current can be expressed in units of ampere-hours. Alternatively, discharge current can be normalized to the rated capacity of the electrochemical cell, and expressed as C/(X t), wherein C is the capacity of the electrochemical cell, X is a variable and t is a specified unit of time, as used herein, equal to 1 hour.

“Current density” refers to the current flowing per unit electrode area.

The term “nanostructured” refers materials and/or structures have a plurality of discrete structural domains with at least one physical dimension (e.g., height, width, length, cross sectional dimension) that is less than about 1 micron. In this context, structural domains refer to features, components or portions of a material or structure having a characteristic composition, morphology and/or phase. Nanostructured materials useful as positive electrode active materials include nanostructured composite particles having a plurality of fluorinated carbon domains and unfluorinated carbon domains. In some embodiments, nanostructured materials of the present invention comprise a plurality of structural domains having different compositions, morphologies and/or phase intermixed on a very fine scale (e.g., at least smaller than 10's of nanometers).

“Active material” refers to the material in an electrode that takes part in electrochemical reactions which store and/or delivery energy in an electrochemical cell. The present invention provides electrochemical cells having a positive electrode with a subfluorinated carbonaceous active material.

As used herein, a carbon nanomaterial has at least one dimension that is between one nanometer and one micron. In an embodiment, at least one dimension of the nanomaterial is between 2 nm and 1000 nm. For carbon nanotubes, nanofibers, nanowhiskers or nanorods the diameter of the tube, fiber, nanowhiskers or nanorod falls within this size range. For carbon nanoparticles, the diameter of the nanoparticle falls within this size range. Carbon nanomaterials suitable for use with the invention include materials which have total impurity levels less than 10% and carbon materials doped with elements such as boron, nitrogen, silicon, tin and phosphorous.

As used herein, the term “nanotube” refers to a tube-shaped discrete fibril typically characterized by a diameter of typically about 1 nm to about 20 nm. In addition, the nanotube typically exhibits a length greater than about 10 times the diameter, preferably greater than about 100 times the diameter. The term “multi-wall” as used to describe nanotubes refers to nanotubes having a layered structure, so that the nanotube comprises an outer region of multiple continuous layers of ordered atoms and a distinct inner core region or lumen. The layers are disposed substantially concentrically about the longitudinal axis of the fibril. For carbon nanotubes, the layers are graphene layers. Carbon nanotubes have been synthesized in different forms as Single-, Double- and Multi-Walled Carbon Nanotubes noted SWCNT, DWCNT and MWCNT respectively. The diameter size ranges between about 2 nm in SWCNTs and DWCNTs to about 20 nm in MWCNTs. In an embodiment, the MWNT used in the invention have a diameter greater than 5 nm, greater than 10 nm, between 10 and 20 nm, or about 20 nm.

Electrodes are manufactured as disclosed herein and as known in the art, including as disclosed in, for example, U.S. Pat. Nos. 4,052,539, 6,306,540, 6,852,446. Briefly, the electrode is typically fabricated by depositing a slurry of the electrode material, an electrically conductive inert material, the binder, and a liquid carrier on the electrode current collector, and then evaporating the carrier to leave a coherent mass in electrical contact with the current collector.

“Room temperature” refers to a temperature selected over the range of about 293 to 303 degrees Celsius.

Aspects of the present invention are further set forth and described in the following Examples.

### EXAMPLE 1

### Low Operational Temperature Li—CFFx Batteries Using Cathodes Containing Sub-Fluorinated Graphitic materials

Overview

Commercial lithium/polycarbon monofluoride batteries [Li—(CF)ₙ] are typically current-limited and are therefore not implemented in high-rate or low-temperature applications. Recent results suggest, however, that CF-based cathodes that use sub-fluorinated CFₓ (SFCFₓ) active materials in a thin electrode form factor are able to support very high currents (up to 5 C) while still providing a significant fraction of their specific capacity. In this Example, the low temperature efficacy of these materials is examined in a −40° C. environment. CF_{0.54} and CF_{0.65} powders were characterized using x-ray diffraction, scanning electron microscopy, and x-ray energy dispersive spectroscopy. These materials were then implemented in a spray-deposited electrode using a 1-mil (˜25 μm) aluminum foil current collector and PVDF as a binder. Electrochemical tests showed that these materials are able to deliver specific capacity values up to 5 times greater than commercial CF_{1.08} powder inserted into identically fabricated test cells tested at −40° C. Testing also indicated that a room-temperature pre-discharge step was necessary to condition the electrode materials before exposure to the low-temperature test environment.

Introduction

There is a need for safe, high energy density primary batteries that can function at low temperatures, −40° C. and below, for a host of aerospace (and other) applications. The existing off-the-shelf suite of batteries capable of providing energy at reasonable rates at these temperatures, including Li—SO₂Cl₂, Li—MnO₂, and Li—SO₂ have lingering safety issues or low temperature energy density values that make the further investigation of new low temperature battery chemistries important. The high energy density and inherently safe nature of the Li—CFₓ electrochemical couple make it very appealing, though this chemistry is thought to be severely rate limited, particularly at low temperatures. It is a goal of the present invention to provide high rate (C/10 to C/20) Li—CFₓ based batteries that can function well in environments no warmer than −40° C., while still providing high energy density. In doing so, we examined the performance of sub-fluorinated CFₓ materials as implemented in a thin electrode form factor.

Commercial Li/CFₓ batteries can deliver up to 700 Wh/kg, 1000 Wh/l, (at room temperature, C/100 rate) and typically use active cathode materials consisting of fluorinated carbonaceous materials such as coke or graphite. These cathodes have compositions typically ranging from CF_{1.05} to CF_{1.1} that can deliver specific capacities in excess of 800 mAh/g at 2.5 Volts under low-rate conditions at room temperature. This cathode material, however, is known to be discharge rate limited, and currents lower than C/50 (battery current 1/50th that of the capacity of the battery divided by 1 hour) are often necessary to avoid cell polarization and large capacity loss. Oftentimes, the low electronic conductivity of CF is cited as the cause of the observed discharge rate limitations, and it has been long been known that there is a strong correlation between cathode thickness and performance; thicker cathodes are prone to be more rate-limited. To this end, a number of Li—CFₓ battery manufacturers, have been developing high-rate CFₓ cells that use thin cathode structures in a spirally-wound configuration. Some very promising results have been recently described, including a 15.5 Ah fully packaged D cell that delivers over 460 Wh/kg at better than a C/8 rate. At −20° F. (−29° C.), these same cells delivered about 12 Ah under a 2 A discharge, with an active cathode materials utilization of over 570 mAh/g. A similar electrode design approach developed had a bulk cathode impedance of 0.0002 ohms/mm2 and was able to deliver over 500 mAh/g active cathode material at a C/20 rate at −30° C. Others have reported that the Li—CFₓ chemistry exhibits substantial self heating under some discharge conditions. While this is a liability at ambient or elevated temperature use, properly designed cells and batteries could take advantage of this effect for very low temperature operation.

To examine the possibility of further augmenting these results, we have taken advantage of the relatively high electronic conductivity sub-fluorinated CFₓ (SFCFₓ) cathode materials. Recently, substantial success has been reported wherein CFₓ with 0.3<x<0.8 has been used in test cells that are capable of discharge rates as high as 5 C at room temperature with excellent capacity retention. It was unknown, however, whether these cathodes would possess the good characteristics at very low temperatures or high rates. This is because it is possible that significantly slower cathode reaction kinetics and lower ion conductivity values at these temperatures could mitigate the benefits observed at room temperature for the enhanced electronic conductivity SFCFₓ materials. Furthermore, the factors that cause the well-known voltage delay effect in Li—(CF)ₙ batteries are likely to be more prominent under high-rate, low temperature conditions and so must be examined and understood if a functional battery is to be eventually produced. The present Example describes the performance of Li—CFₓ test cells based on SFCFₓ active cathode materials and electrolytes designed to function well at low-temperatures. A series of test cells based on commercially-supplied CF_{1.08} powders were tested in parallel in identical test cells.

Experimental

Materials Fabrication and Analyses:

A monel boat, containing Madagascar natural graphite (30 g) with average particle size of about 10 μm, was placed in a nickel reactor and heated under pure fluorine gas flow at 375 and 390° C. during 17 hours to produce CF_{0.54} and CF_{0.65}, respectively. The products and were analyzed using x-ray diffraction (Cu K_{α}radiation), scanning electron microscopy (SEM) and x-ray energy dispersive spectroscopy (XEDS).

Electrochemical Analyses:

Spray-deposited cathodes were fabricated using SFCFₓ powders that were prepared using a mix consisting of 80 wt %, 10 wt % carbon black in a NMP solution solvating 10 wt % PVDF (pre-stirred solution). As a control, a commercial CF_{1.08}-based cathode mixture was also produced which had a similar overall fluorine mass fraction as in the CF_{0.54} mix (and so therefore had a higher carbon-diluent-to “active material” ratio). Specifically, these baseline cathodes contained 30 wt % C black, 60 wt % CF_{1.08} and 10 wt % PVDF. In all cases the fully intermixed slurry (as mechanically stirred for at least 12 hours) was spray-deposited in multiple layers onto a roughened 1-mil thick Al foil current collector. The resulting physically robust cathode structures, 1 to 3 mils in thickness, were vacuum-furnace dried for 24 to 48 hours at ˜105° C. 2032 size coin cell test cells were then fabricated using 16 mm diameter cathode disks, a single layer of Tonen separator, and a 16 mm diameter Li foil anode.

The electrolytes contained 1 M LiBF₄ salt solvated in a mix of either propylene carbonate (PC)+1,2,-dimethoxy ethane (DME) in a 20/80 or 50/50 v/v % ratio. Since these electrodes were so thin, the variation in wettability between these two solvent compositions was not found to have a significant effect on cell performance. A series of electrolytes made using various solvent additives has also been performed, and will be reported on elsewhere in detail.

Electrochemical testing consisted of galvanostatic discharges at room temperature and −40° C. under currents consistent with rates ranging from 2 C to C/40. These rate values were calculated using the nominal room-temperature specific capacities that have been previously published for these SFCFₓ materials. A room-temperature pre-discharge step of 3% of the total estimated cathode capacity at a C/33 rate was employed in most cases. Electrochemical impedance spectroscopy (EIS) in the potentiostatic mode (5 mV signal amplitude, 10⁻² to 10⁵ Hz frequency range) was carried out to examine the effect of this pre-discharge on the cathode an anode.

Results

Materials Characterization

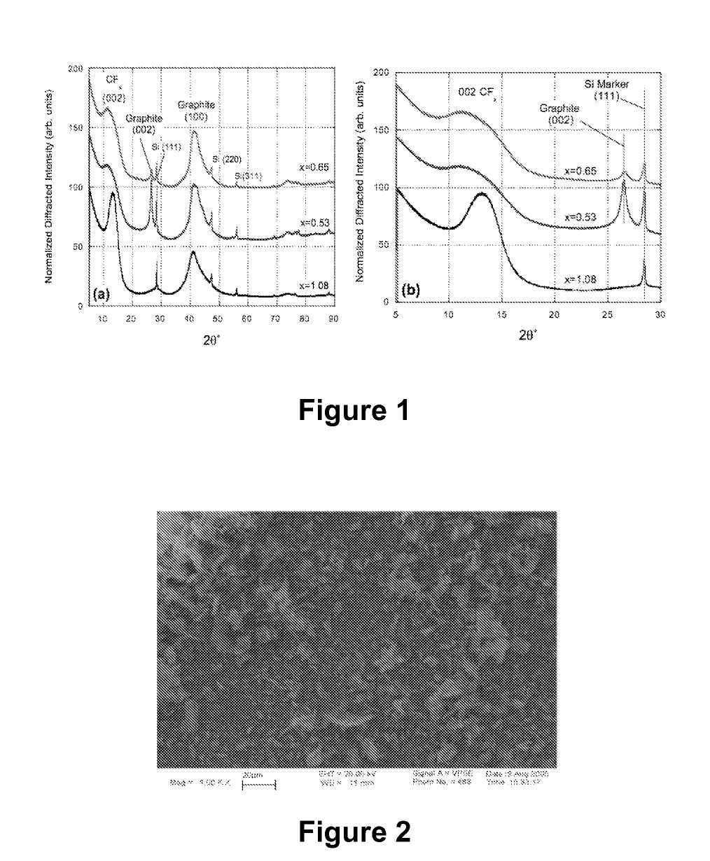

FIG. 1 shows x-ray diffraction data collected from the SFCFₓ materials for x=0.54 and 0.64. These data show that both pristine graphite as well as fluorinated CF materials were present. There was more graphitic C in the CF_{0.54} than in the CF_{0.64}, and there is no evidence of staging in the fully un-fluorinated material (the graphite peak is at the same location for both cases). The broad diffraction peaks from the fluorinated material present in the samples are similar in both of the SFCFₓ materials and are consistent with those found in carbon materials that have been uniformly fluorinated to approximately CF_{0.8}.

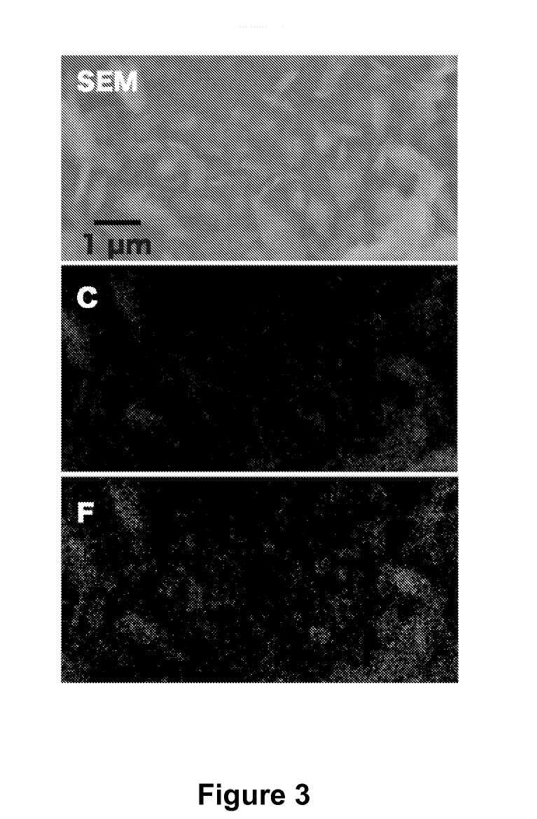

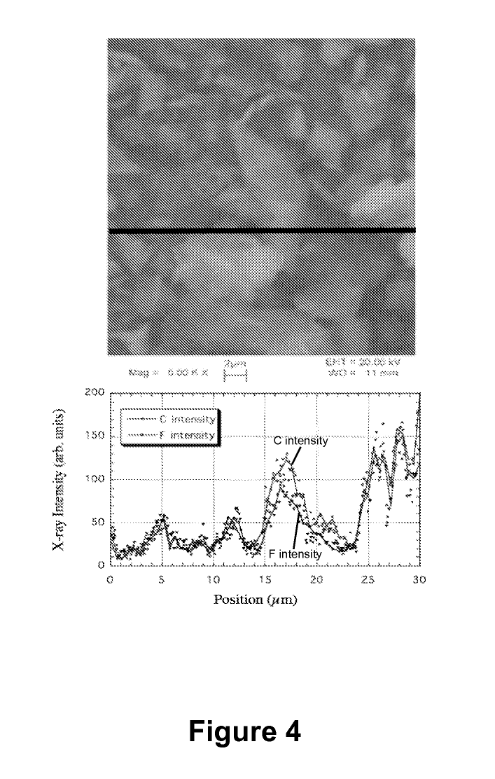

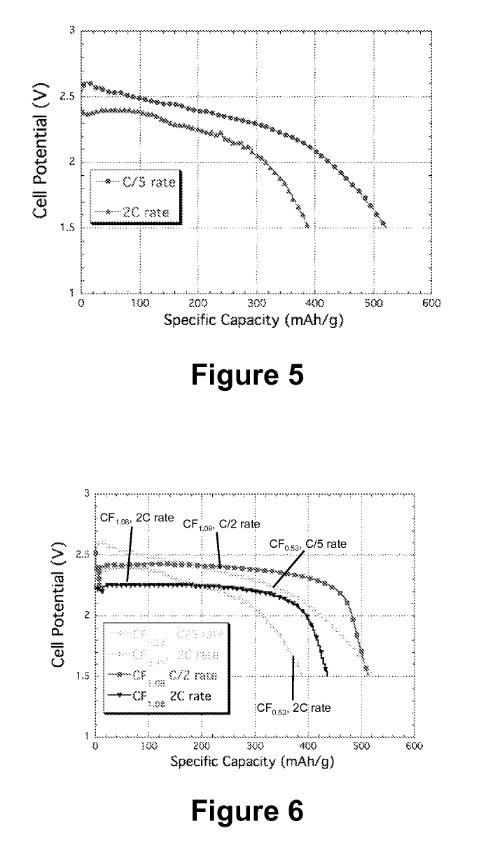

Scanning electron micrographs of this material are shown in FIG. 2. The powders consisted of flakes of material varying in size from less than 1 micron to over 10 microns in diameter. The flakes had a similar morphology as unfluorinated graphite. FIG. 3 contain XEDS elemental mapping data of the CF_{0.54} material. These data show that the C and F atoms in the material are generally well mixed such that the F signal is observed on each C flake. FIG. 5 is a long-acquisition time elemental XEDS line scan indicating, once again, that the F is fully and equally dispersed in the graphitic flakes. These data show that the CFₓ powder was not a mix of unfluorinated graphite particles mixed with fully fluorinated CF, but rather that each flake contained both un-fluorinated graphite and CF_{y}.

Electrochemical Characterization

Room Temperature characterization: A number of room-temperature discharges were conducted to characterize the CFx materials. In these cases, the electrolyte consisted of either 1.0 M LiBF₄ in PC+DME (20/80 or 50/50 v/v %). FIG. 5 shows the discharges of Li—CF_{0.54} cells at room temperature at 2 C and C/5 rates. The capacities realized from these cells are very similar to those reported in the literature and indicate that these materials performed as expected.

The baseline cathodes fabricated using commercial CF_{1.08} and 30 wt % carbon black material were also discharged at room temperature at high rates, as shown in FIG. 6. These materials delivered slightly higher specific capacities. In this case 80% of the total cathode mass was defined as the “active material” mass to allow for a reasonable comparison with the SFCFₓ containing cathodes.

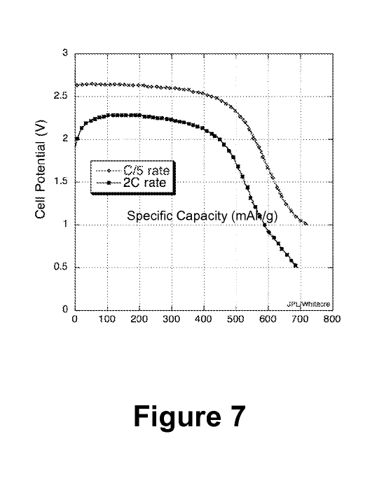

Room temperature discharge data from a CF_{0.65} cathode are shown in FIG. 7. These data are also consistent with previously published data: a specific capacity of over 700 mAh/g was attained at a C/5 rate, with a discharge voltage in excess of 2.5 V. The initial voltage plateau was also more constant than in the CF_{0.54}-based cells.

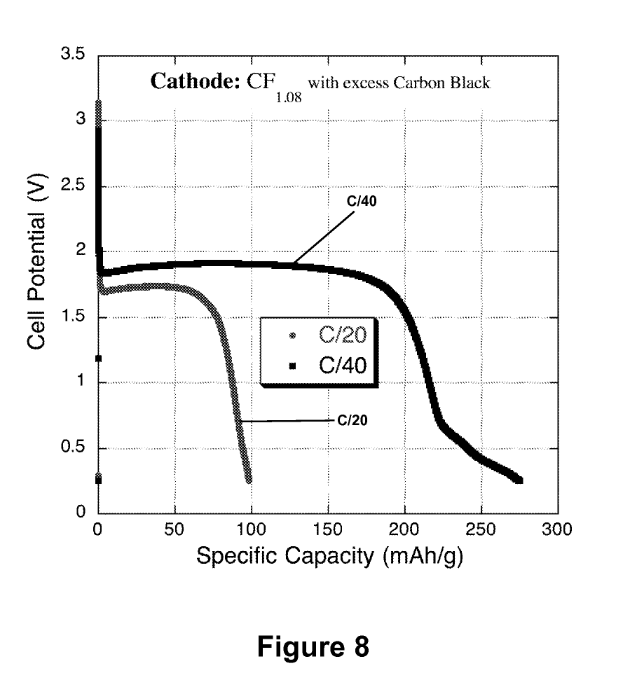

Low Temperature Testing: Test cells made from the same materials as for the room temperature testing were discharged at −40° C. FIG. 8 shows the performance of the CF_{1.08} based cathode material at −40° C. (using 20/80 PC/DME electrolyte solution) in two separate cells using C/20 and C/40 rates (with room temperature pre-discharge). About 200 mAh/g was extracted at a C/40 rate, while less than 100 mAh/g was attained at a C/20 rate, results that are nominally consistent with those published previously for CF_{1.08} based cathodes at low temperatures.

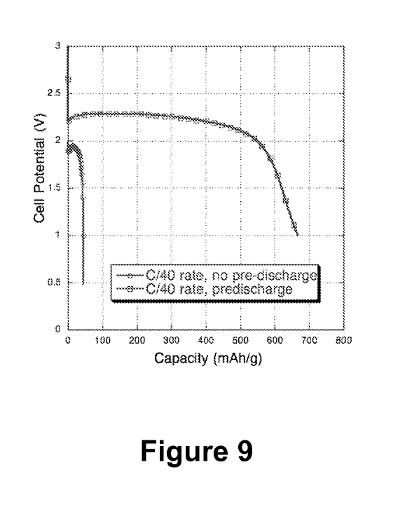

FIG. 9 shows the −40° C. performance of Li—CF_{0.65} cells (using 20/80 PC/DME electrolyte solution) with and without the room temperature pre-discharge step. A capacity of 600 mAh/g was extracted from the cathode that had undergone the pre-discharge. This experiment was repeated several times using different electrolytes and cathode materials and the results were similar: the pre-discharge was useful for enhancing the performance of the cells at low temperatures. For this reason, this conditioning step was adopted and used for most experiments in this Example.

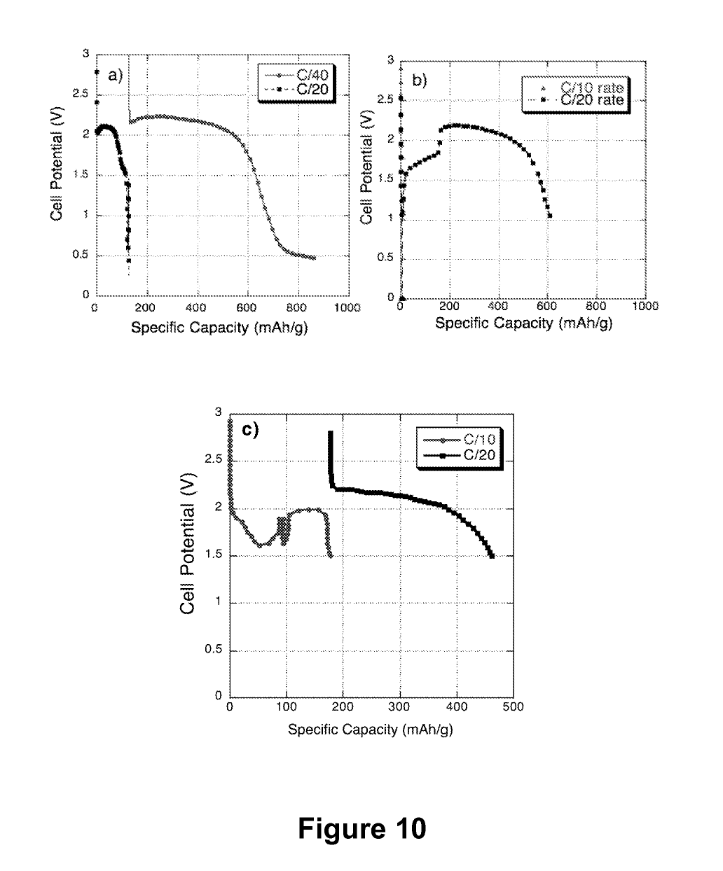

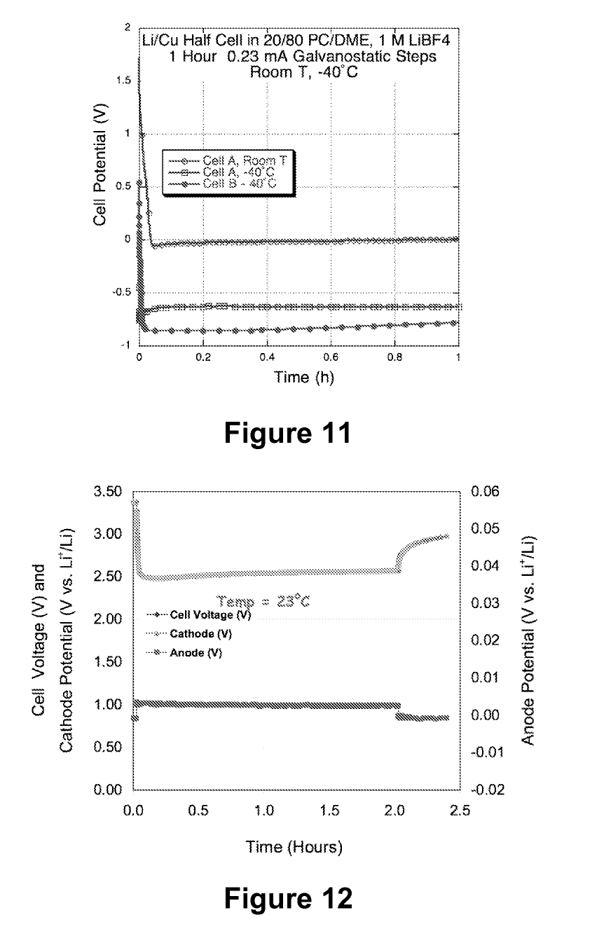

FIG. 10 shows discharge curves from CF_{0.65} and CF_{0.54} cells at −40° C., using multiple discharge rates in succession. In FIG. 10(a), a CF_{0.65} and cell was first discharged at a C/20 rate (to 0.5 V) followed by a discharge at a C/40 rate, while in (b) the respective rates were C/10 and C/20 on a CF_{0.65} cell. In this case, the total capacity delivered under a C/20 discharge current was greatly enhanced if preceded by a C/10 discharge. This effect was not observed in all cases, however, as can be seen in FIG. 11(c) showing the performance of Li—CF_{0.54} under C/10 followed by C/20 discharge rates, where an inconsistent discharge potential was observed at a C/10 rate through 170 mAh/g of capacity. The C/20 discharge on the same cell was smooth and the cell provided a total of 460 mAh/g.

Table 1 contains a partial list of test cells, composition, test conditions, and resulting capacities.

TABLE 1
Partial List of test cells, discharge conditions, and specific
capacity/energy values (as calculated based on cathode
active material mass content).

| Cathode | Thickness | | Electrolyte | Temp | Discharge Rate | Cap. (mAh/g) |
|---|---|---|---|---|---|---|
| CF_{1.08} | <1 | mil | Baseline 80/20 | 20° C. | 2 C | 430 |
| With excess C | | | DME/PC | | | |
| CF_{1.08} | <1 | mil | Baseline 80/20 | 20° C. | C/2 | 510 |
| With excess C | | | DME/PC | | | |
| CF_{1.08} | <1 | mil | Baseline 80/20 | −40° C. | C/20 | 75 |
| With excess C | | | DME/PC | | | |
| CF_{1.08} | <1 | mil | Baseline 80/20 | −40° C. | C/40 | 200 |
| With excess C | | | DME/PC | | | |
| CF_{1.08} | <1 | mil | TFMPC/PC/DME | −40° C. | C/40 | 290 |
| With excess C | | | 5/15/80 wt % | | | |
| GenII CF_{0.53} | ˜1 | mils | Baseline 80/20 | 20° C. | C/5 | 610 |
| | | | DME/PC | | | |
| GenII CF_{0.53} | ˜1 | mils | Baseline 80/20 | 20° C. | 2 C | 390 |
| | | | DME/PC | | | |
| GenII CF_{0.53} | ˜1 | mils | Baseline 80/20 | −40° C. | C/10 | 393 |
| | | | DME/PC | | C/20 | +59 |
| | | | | | | 443 |
| GenII CF_{0.53} | ˜1 | mils | Baseline 80/20 | −40° C. | C/10 | 334 |
| | | | DME/PC | | C/20 | +109 |
| | | | | | | 452 |
| GenII CF_{0.647} | ˜2-3 | mils | Baseline 80/20 | 20° C. | C/5 | 500 |
| | | | DME/PC | | | |
| GenII CF_{0.647} | ˜2-3 | mils | Baseline 80/20 | 20° C. | 2 C | 525 |
| | | | DME/PC | | | |
| GenII CF_{0.647} | ˜2-3 | mils | Baseline 80/20 | −40° C. | C/40 | 630 |
| | | | DME/PC | | | |
| GenII CF_{0.647} | ˜1 to 2 | mil | PC/DME 50/50 | −40° C. | C/40 | 610 |
| GenII CF_{0.647} | ˜1 to 2 | mil | PC/DME 20/80 | −40° C. | C/40 | 615 |
| GenII CF_{0.647} | ˜2-3 | mils | TFMPC/PC/DME | −40° C. | C/20 | 110 |
| | | | 5/15/80 wt % | | C/40 | +510 |
| | | | | | | 620 |
| GenII CF_{0.647} | ˜2-3 | mils | TFMPC/PC/DME | −40° C. | C/10 | 10 |
| | | | 5/15/80 wt % | | C/20 | +570 |
| | | | | | | 580 |

Discussion

Microstructure: The characterization data indicate that the SFCFₓ materials were comprised of pristine un-fluorinated graphite mixed intimately with fluorinated C, and are consistent with data reported previously. The SEM/XEDS analyses indicate that the C and F are intermixed at a very fine scale (at least smaller than 10's of nm), while the XRD data show that the graphitic material that has undergone fluorination is likely fluorinated to the same degree regardless of the total fluorination of the sample (i.e. x in CFₓ). There is also no evidence of graphitic gallery staging at the various levels of fluorination. The combination of these indicators suggests that the microstructure of this material is a collection of nano-dimensional graphite and CF_{y} domains, where y is approximately 0.8 to 0.9. The small scale of these compositionally variant regions dictates that the material have a very high graphite-to-CF_{y} surface area and subsequently will posses excellent electronic/interface transport properties at all temperatures.

Although thermodynamically predictable, the fluorination of graphite is kinetically unfavorable as it requires the following: i) separation of the graphene layers to allow for fluorine diffusion, ii) change in the carbon hybridization from stable sp² to less stable sp^{3,} and iii) dissociation of the F₂ molecule. At constant temperature and fluorine pressure, the chemical activity of fluorine decreases with the depth of fluorine penetration within the layers. Consequently, the rate of the fluorination reaction (C+y/2F₂=CF_{y}) should decrease as the diffusion layer becomes thicker, which eventually leads to an equilibrium state in which possibly a fraction of carbon remains unreacted. At 375 and 390° C. used to prepare CF_{0.54} and CF_{0.64} samples respectively, under 1 atmosphere fluorine pressure, the practical end point is reached after 17-hours reaction. Both samples show unreacted graphite.

Electrochemical Behavior: To establish that this uniquely structured material offers some benefits compared to state-of-the-art (CF)ₙ cathode materials, it was necessary to create a control cathode based on commercially available CF_{1.08} that had the same fraction of fluorine in the as-tested cathode structure. Relatively large quantities of C black were used to lower the total F content in these cathodes to the same level as found in the CF_{0.54}-based cathodes (which used 10 wt % carbon black). At room temperatures, there was little difference between the SFCFₓ material and the industry baseline, as seen in FIG. 6. Though the CF_{0.54} material had a higher potential initially, this material had a discharge plateau that was more sloping, and actually delivered less capacity at room temperature than the CF_{1.08} cathodes. This result is not unexpected, as the very thin cathode form factor used in these cells likely minimized the beneficial effects of the enhanced conductivity found in the SFCFₓ materials. It is possible that substantially thicker cathode structures would allow for the difference in performance between the CF_{1.08} and the CF_{0.54} to be resolved.

At −40° C., however, the commercial CF_{1.08} baseline and SFCFₓ cathode materials behaved differently. In particular, the CF_{1.08} yielded significantly lower capacities at lower discharge potentials than the SFCFₓ materials, even though the latter were in a slightly thicker electrode form factor, as summarized in table 1. The CF_{1.08}-based cathodes typically delivered one-third the capacity of the CF_{0.65} material under identical conditions. The result is more pronounced when considering the fact that the baseline material cathodes also polarized to a greater degree, thereby offering a energy density.

This result indicates that the nano-scale intermixing of graphitic and CF_{y} materials is important for low-temperature performance, and cannot be emulated by physically mixing high surface area carbon materials with CF_{1.08} as which was shown to be sufficient for higher temperature testing environments. The two main differentiating features of the SFCFₓ material compared to the CF_{1.08} were (1) higher surface-area-to-mass ratio for the active CF_{y} domains, and (2) the existence of nano-scale electronically conductive pathways.

The capacity/energy density of a D-sized cell produced using the CF_{0.647} cathode material can now be estimated (for a −40° C., C/40 discharge condition). It is assumed that the CF_{0.647} active material may be inserted into the same cell structure the 15.5 Ah D-size LiCFₓ battery described in the introduction. Substituting 600 mAh/g CF_{0.647} into this cell format results in a cell with an energy density of about 400 Wh/kg when discharged at a C/40 rate at −40° C.

It was found that the low-temperature performance of all CFₓ materials was greatly enhanced if a small, room temperature pre-discharge was used. This protocol is used for industrially-fabricated Li—CFₓ batteries to condition the electrode/electrolyte interfaces. The observed effect could have been a result of the existing native Li anode passivation layer of LiOH species that is removed with a short discharge. To examine this possibility, several Li half-cells (using Cu foil as a counter electrode) were constructed with the same electrolyte/salt/separator as used in the full Li—CFₓ cells. −40° C. galvanostatic electrochemical tests were conducted on cells that both had and had not been subjected to the room temperature galvanostatic conditioning step identical to that used in the full cells. FIG. 11 shows the results: after a 1-hour of discharge at −40° C., there was approximately a 0.15 V difference in the Li/Cu plating potential (under a galvanostatic condition) between the half cell that did and the half cell that did not undergo the room temperature conditioning. The magnitude of this differential is significantly smaller than that observed for the full cells discharged and without room temperature conditioning (as seen in FIG. 9).

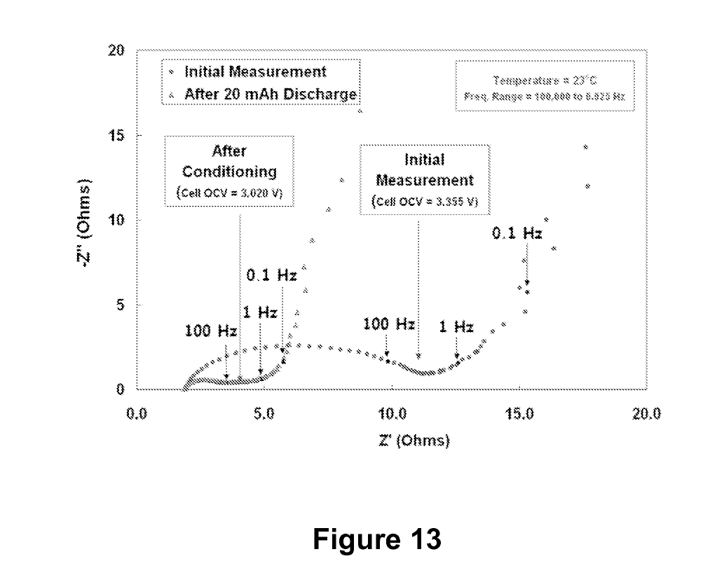

Other tests using a flooded three-electrode glass cells indicated the same result. FIG. 12 shows the anode, cathode and full cell potential (vs. Li reference electrode) as a function of time during a 2 hour pre-discharge of a thick CF_{1.08}-based cathode. During the discharge, the anode polarizes approximately 5 mV, while the cathode potential varies though a range of nearly 1 V. EIS analyses on the cathode of this cell before and after the pre-discharge are conclusive (FIG. 13): the cathode interfacial resistance decreased to about 20% its pre-discharge value. These results are consistent with the idea that the voltage delay/pre-discharge effects are driven by cathodic mechanisms. It is possible that the pre-discharge encourages the formation of an unfluorinated C layer at the electrode/electrolyte interface as a result of the cathode process (CFₓ+εLi⁺+εe=εLiF+ε/xC+(1−ε/x)CFₓ). Such an in-situ formed layer would enhance electrolyte wettability as well as the electrode conductivity.

Another relationship is indicated in FIG. 10, where it is shown that high-rate discharges at −40° C. can improve subsequent performance in lower rate discharging at the same temperature. FIG. 10(a) shows that an initial C/20 rate discharge yields about 150 mAh/g of capacity in a Li/CF_{0.647} cell. FIG. 10(b) indicates that if a very short C/10 rate discharge preceded a C/20 discharge, over 500 mAh/g was extracted for this similar cell. There is a voltage recovery event early on in this C/20 discharge, which may also be indicative of a variety of possible electrode conditioning effects. In other cases, significantly more capacity was extracted at a C/10 rate at −40° C., as in FIG. 10(c). Our results are consistent with the idea that the increased electrolyte viscosity at low temperatures disallows uniform electrode surface wetting, thereby resulting in a fluctuating (sometimes to catastrophic levels) discharge potential. Data from cells using a lower viscosity electrolyte display more consistent behavior.

### CONCLUSIONS

This Example shows that the nano-scale intermixing of graphitic domains and CF_{y} found in sub-fluorinated CFₓ (SFCFₓ) materials greatly benefited the specific capacity of these materials when discharged at low temperatures using aggressive current densities. The performance of SFCF_{X} materials was compared to industry-standard, fully-fluorinated CF_{1.08} powders inserted in otherwise identical test cells. The SFCFₓ and CF_{1.08} active material yielded nearly the same specific capacity values at room temperature at rates as high as 2 C. However the SFCFₓ gave a 3 times (or greater) capacity value at −40° C. using rates up to C/10. The results also indicate that a room-temperature pre-discharge is important to low-temperature performance, an effect attributed to the kinetically-motivated cathode depassivation/conditioning events that occur upon initial discharge. It is likely that the pre-discharge results in the evolution of a fluorine-free C layer at the electrode/electrolyte interface that would subsequently enhance electrolyte wetability and conductivity. These results show that the high specific capacity SFCFₓ cathode chemistry is a viable intermediate rate low-temperature battery cathode material if prepared in a sub-fluorinated state and implemented in a sufficiently thin-electrode cell design.

### Example 2

### Enhanced Low-Temperature Performance of Li—Cfₓ Batteries

Overview

This example describes the continued examination of the low-temperature performance of the Li—CFₓ electrochemical couple in a −40° C. or colder environment. Previously, the efficacy of sub-fluorinated CFₓ (SFCFₓ) cathode active materials was demonstrated; preliminary results indicated that the material was functional at rates up to C/10 at −40° C., however there were often substantial voltage fluctuations during discharge, accompanied with inconsistent capacity yields and sometimes dramatic polarization events. In the research described herein, an investigation of various electrolyte and cathode compositions was conducted in an effort to optimize performance. In particular, several different electrolyte solvent formulations were examined using a salt content of either 1 M or 0.5 M LiBF₄. A further modification consisted of addition of an anion-receptor to the electrolyte that was intended to be a LiF-solvating agent. The most promising electrolyte was tested with several different SFCFₓ compositions created using either graphitic or multi-wall nanotube precursor materials. Electrochemical evaluation showed that the best SFCFₓ-based test cells were able to deliver specific capacity values up to 5 times greater than control cells (containing conventional CF_{1.08} powder) at −40° C. under discharge currents as high as C/5 with composite electrodes thicker than 50 μm.

Introduction

Recently, it has been reported that sub-fluorinated CFₓ (SFCFₓ) materials (where 0.3<x<0.66) are capable of supporting discharge rates as high as 5 C at room temperature with excellent utilization. It was unknown, however, whether these cathodes would possess good characteristics at very low temperatures at aggressive rates (i.e. greater than C/100). The significantly slower cathode reaction kinetics and/or lower electrolyte ionic conductivity values at these temperatures could mitigate the benefits observed at room temperature. Furthermore, the factors that cause the voltage delay effect in Li—(CF)ₙ batteries are likely to be more prominent under high-rate, low temperature conditions and therefore must be examined if a functional battery is to be eventually produced. Preliminary results show that the sub-fluorinated CFₓ materials did exhibit superior low-temperature performance at −40° C. compared to baseline CF₁, though at current levels not exceeding a C/20 rate. Two electrolyte blends were compared: 1 M LiBF₄ solvated in a DME/PC mix to a ratio of either 80/20 v/v % or 50/50 v/v %. The 80/20 v/v % DME/PC-based electrolyte had superior performance at low temperatures, though there were still significant variations in cell performance at higher rates at −40° C. It was unclear whether this erratic behavior was due to the inherent properties of the electrolyte, interfacial properties (i.e., cathode surface wettability), or the re-distribution of reaction byproducts (LiF) upon discharge.

The focus of the present Example is to further improve low-temperature functionality by matching the highest capacity sub-fluorinated cathode active material with the proper electrolyte blend and electrode form factor. In particular, three different electrolytes were tested at low temperatures with a standard Li—CF_{0.65} cell. The best electrolyte was then used to test several variations of sub-fluorinated CFₓ cathode material. These results were compared to those obtained from cathodes produced using commercially available CF_{1.08}. In some cells, a solvating anion receptor additive was also inserted into the electrolyte with the intention of reducing cathode surface Li—F passivation, thereby increasing the electrode functionality. The most promising test cells were able to support substantial discharge currents at temperatures colder than −40° C., with composite cathode thicknesses exceeding 110 μm.

Experimental Procedure

A standard test vehicle was adopted that consisted of a spray-deposited cathode layer containing 10% PVDF binder, 10% carbon black, and 80% active material on a 1-mil thick Al current collector foil (and spray-deposited onto the heated Al current collector). These composite cathodes ranged in thickness from 10 μm to 120 μm, with the most commonly tested thickness being about 40 μm +/−5 μm. The relationship between electrode mass and thickness was determined using a precision caliper on the thicker samples (>50 μm). The standard test cell consisted of 2032 coin cells with a Li metal anode, and a single layer of polypropylene (Tonen™) separator. The control electrode, based on CF_{1.08} as received from a commercial vendor, contained 30 wt % carbon black and 10 wt % PVDF. This resulted in a composite electrode capable of similar room temperature performance (per unit mass of the total composite electrode) as a CF_{0.55}-containing electrodes.

A representative SFCFₓ electrode composition and thickness, CF_{0.65} and 40 μm +/−5 μm thick, was first used to identify promising electrolyte blends for low temperature performance. The selected electrolyte blends are indicated in Table 2.

TABLE 2
Electrolyte solvent/salt blends initially tested for
low-temperature efficacy in the Li/CFₓ test cells.
The performance of 1 M LiBF₄ solvated in 50:50 v/v %
PC/DME at low temperatures is published elsewhere.

| Solvent | Salt |
|---|---|
| PC/DME (2/8 v/v %) | 1 M LiBF₄ |
| PC/TEE/DME (2/2/6 v/v %) | 1 M LiBF₄ |
| PC/DME (2/8 v/v %) | 0.5 M LiBF₄ |

The lithium tetrafluoroborate used was battery grade and obtained from Mitsubishi Petrochemicals Co. and vacuum dried prior to use. The propylene carbonate (PC) and 1,2-dimethoxyethane (DME) were also high purity battery grade and obtained from Mitsubishi Petrochemicals Co. and used as received. The trifluoroethyl ether (TEE) was synthesized by a known method consisting of the acid catalyzed dehydration reaction of 2,2,2-trifluoroethanol.

The rationale for incorporating ethers bearing fluoroalkyl groups in electrolyte formulations is two-fold: (a) they are envisioned to impart beneficial physical properties to the electrolyte, due to their low viscosity, low melting points, and good solvating properties, and (b) the hydrofluorocarbon ethers are anticipated to better wet the CFₓ electrode improving the mass transport properties. The optimization of the PC+DME blends is based upon the balance of having adequate proportion of the high dielectric constant component (PC) and sufficient proportion of the low viscosity, good coordinating component (DME). During the course of optimization of these electrolytes for low temperature operation, higher conductivity is observed with electrolyte formulations containing low PC content and low electrolyte salt concentration. In addition to these factors, the primary solvent either EC or PC, needs to be in adequate proportion to impart passivation to the anode (and hence shelf life to the cell), but not high enough to contribute to higher viscosity at low temperatures.

Upon determining the highest performing electrolyte, at low temperatures, of those examined, test cells were made and tested using four different cathode active materials; three were SFCFₓ-based, and the last was the CF_{1.08}-based standard. The CF_{0.65} electrodes used partially fluorinated Madagascar graphite precursor, while the other two SFCFₓ variations contained CF_{0.59} or CF_{0.82} material made using multi-wall carbon nano-tube material precursor materials supplied by MER Corporation. Characterization data indicated that all of the SFCFₓ materials were comprised of pristine un-fluorinated graphite domains mixed intimately with nano-dispersed near-fully fluorinated graphitic regions, and are consistent with data reported previously. The small scale of these regions dictates that the materials had a very high graphite-to-CF surface area and subsequently might possess excellent electronic/interfacial transport properties.

In several of the 0.5 M LiBF₄ in DME/PC (80:20) containing cells, an anion receptor Lewis acid additive, tris(2,2,2-trifluoroethyl) borate (TTFEB), was also dissolved into the electrolyte solvent in an effort to decrease or eliminate the LiF (discharge reactant) buildup via a F⁻complexing reaction. Such an approach is also useful for enhancing the solubility of lithium salts. The nominal TTFEB concentration in the electrolyte solution was 1.5/98 v/v % TTFEB/(DME/PC (80/20).

Previous work (See, Example 1) indicated that a room-temperature pre-discharge step (consisting of a 1 hour, discharge at a C/33 current level) was necessary to prepare the electrode interfacial regions to accommodate low-temperature discharge. This preparation was used here for most test cells, however, the necessity of this pre-discharge was re-examined for the most promising electrode/electrolyte combinations. In all cases, the C rate was calculated based on the expected room-temperature capacity of the cathode if discharged at a C/40 rate.

Results

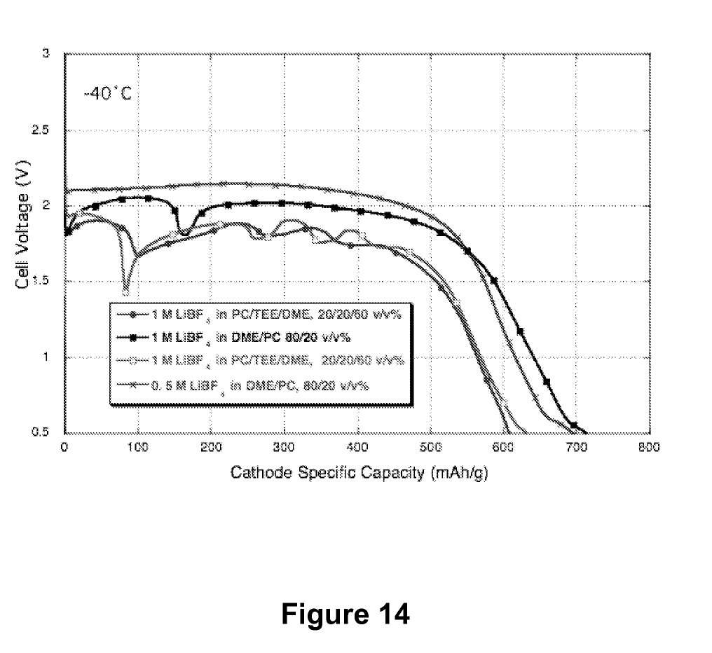

FIG. 14 shows discharge data from CF_{0.64} SFCFₓ active material cells using a C/10 discharge rate at −40° C. with the different electrolytes listed in Table 2. The best (highest power, smoothest discharge curve) result was obtained with 0.5 M LiBF₄ solvated in an 8/2 (v/v %) DME/PC blend. Test cells made with electrolytes that had a higher salt content (1 M), were more rate-limited and had erratic potential variations during discharge at these low temperatures. Repeated testing supports this finding. Those cells that polarized rapidly were still functional and displayed smooth discharge curves and good discharge capacities at lower rates (C/20 or slower) at −40° C.

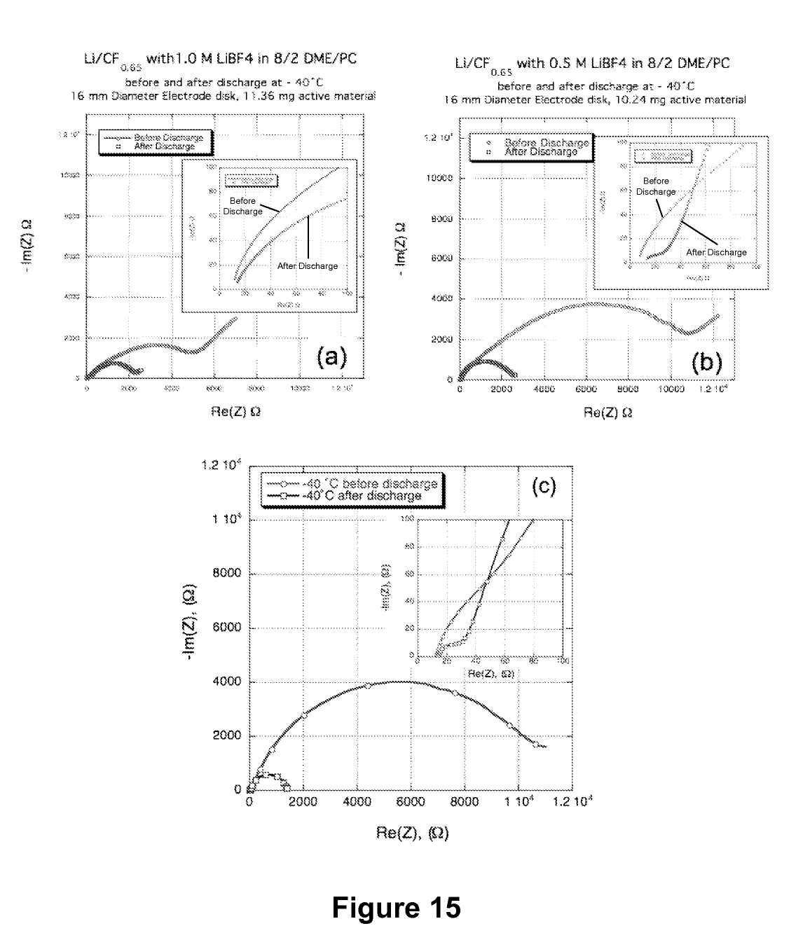

The execution of the pre-discharge step in the 0.5 M salt content cells was found to have no effect on low-temperature performance, much in contrast to the results obtained using electrolytes containing higher salt concentrations. EIS data collected from test coin cells with stainless-steel blocking electrodes indicate that the 1 M salt content electrolyte had approximately twice the high frequency, real-axis intercept at −40° C. compared to the 0.5 M salt containing blend. FIG. 15 shows EIS data from Li/CF_{0.64} cells with either a 1 M or 0.5 M salt content. FIG. 15(c) contains the same data for a 0.5 M salt content cell with the anion receptor additive. All of these cells had similar active material masses, and similar impedance characteristics after discharge.

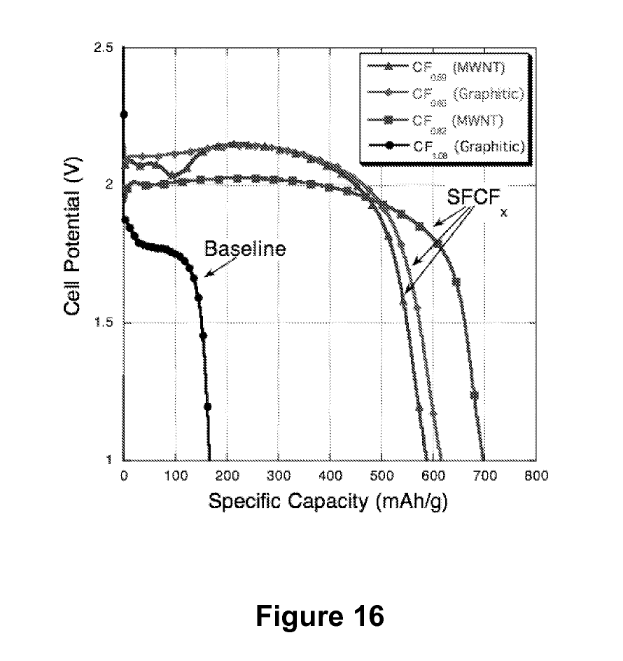

FIG. 16 shows a comparison between the −40° C. temperature performances of various CFₓ cathodes (of similar mass/thickness) as discharged at C/5 rate using the 0.5 M LiBF₄ solvated in 8/2 (v/v %) DME/PC electrolyte. The delivered capacities for the SFCFₓ cathodes were as much as 300% greater with the subfluorinated cathodes than that of the CF_{1.08} baseline cathode under identical discharge conditions. Multiple electrodes were tested for each electrode composition with consistent results.

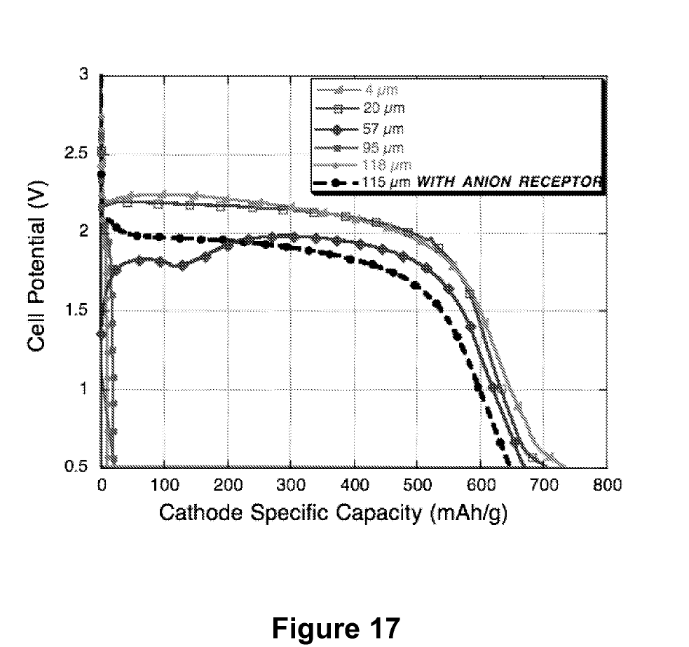

The nominal maximum usable composite cathode thickness has previously been found to have a strong negative correlation with the maximum usable discharge rate or realized discharge capacity in the Li—CFₓ chemistry and was therefore examined here under low temperature conditions. FIG. 17 shows the behavior of CF_{0.65} composite cathodes with thicknesses varying in from 4 to 118 μm at a C/5 discharge rate. The cells delivered nearly full capacity, with some polarization and voltage delay, up to a thickness of at least 57 μm. Cathodes as thick as 95 μm or higher were severely polarized upon discharge under these conditions, but were able to deliver full capacity at reduced discharge rates, for example at C/10 rate for the 95 μm cathode and a C/40 rate for the 118 μm thick cathode.

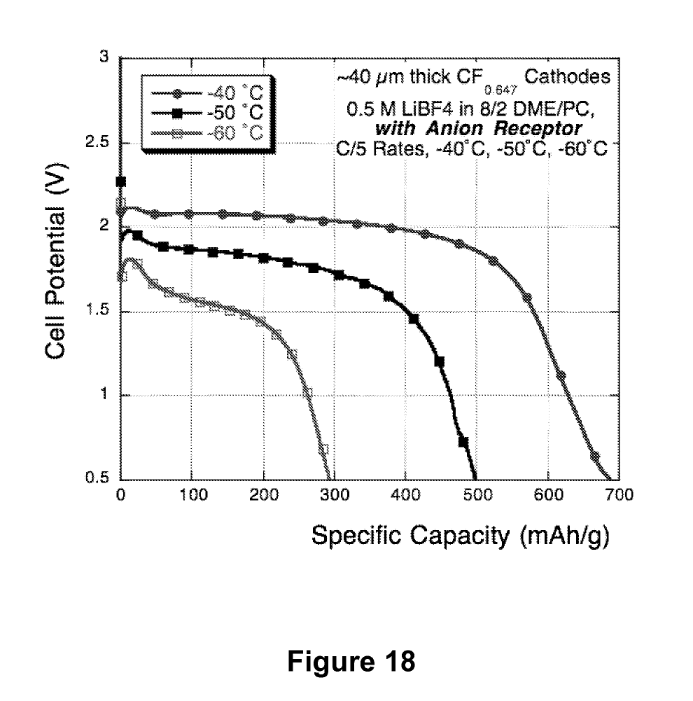

The use of the TTFEB anion-receptor additive resulted in even thicker composite electrodes that could be made functional at these temperatures. FIG. 17 also contains the results from a 115 μm-thick CF_{0.65} cathode discharged at a C/5 rate at −40° C. with the anion receptor additive. FIG. 18 contains plots of Li—CF_{0.65} cells made using TTFEB anion receptor in 0.5 M LiBF_{4,} 8/2 PC/DME electrolyte and discharged at progressively lower temperatures at a C/5 rate. Even at −60° C., smooth discharges were observed and a specific capacity nearly 275 mAh/g was obtained. In all cases, those cells made with the anion receptor additive did not exhibit any noticeable voltage delay effects, even without the execution of a room temperature pre-discharge step. There was, instead, a characteristic positive voltage excursion upon discharge.

Discussion

A decrease in the electrolyte salt content from 1 M to 0.5 M in an 80/20 v/v % DME/PC solution has further enhanced the low temperature performance of the Li/SFCFₓ electrochemical couple compared to previously published results. This improvement can be attributed to at least one of several mechanisms, including enhanced low temperature electrolyte conductivity, or a relative decrease in surface precipitation on the active cathode material surfaces. There is not as yet conclusive proof as to which of these mechanisms (if either) are at work, and this effect bears further examination. The impedance spectroscopy data indicate, however, that there is not a substantial difference between the electrode impedance as a function of salt content, which indicates that the enhancement mechanism is not directly related to the IR losses associated with an SEI layer. The cathode impedance is substantially reduced after discharge, in solutions with either 0.5 M or 1.0 M salt concentration, with or without the anion receptor additive. Furthermore, previous results on three-electrode cells indicate that much of the change in series resistance occurs on the cathode side of the cell under these conditions. Even though the series resistance, reflected in the x-axis intercept at high frequencies, does not change, the low frequency impedance is significantly reduced. This may be due to inadequate wetting of the interface before discharge, or could be due to the insulating nature of a native film that forms on the cathode before discharge.

The fact that a room-temperature pre-discharge is not required using the lower salt content electrolyte blend is consistent with the idea that some portion of the electrolyte salt reacts with the cathode material upon contact to form interfacial film that impedes the cathodic reaction in some way, particularly at discharge commencement. Lowering the salt content may result in a less robust cathode surface film that may subsequently reduce or negate the need for a pre-discharge step.

The fact that the addition of an anion receptor, tris (2,2,2-trifluoroethyl borate, known to dissolve LiF results in a further performance enhancement is also consistent with this notion. In intermediate cases (i.e., C/10 or higher rates, or around 50 μm in thickness), a substantial voltage delay was observed for cells without any anion receptor, such as that for the 57 μm thick CF_{0.65} cathode discharged at a C/5 rate at −40° C. (FIG. 17). In this case, the voltage delay lasted about half of the discharge, though eventually the cell became fully functional, albeit slightly polarized. This reproducible voltage delay behavior was not observed in any of the anion-receptor containing cells, even when discharged at a C/2.5 rate or at temperatures or colder than −40°. These observations (when combined with previous results that showed large fluctuations of the cathode impedance before and after discharge) are consistent with the idea that the voltage delay observed in the Li—CFₓ couple is related to a native cathode surface film that is only partially affected when using the pre-discharge step. The anion receptor apparently mitigates all of the negative affects of this layer, and may do so by dissolving some of the interfacial layer assumed to primarily be comprised of LiF, thereby allowing high-rate discharge at relatively cold temperatures without catastrophic cell polarization.

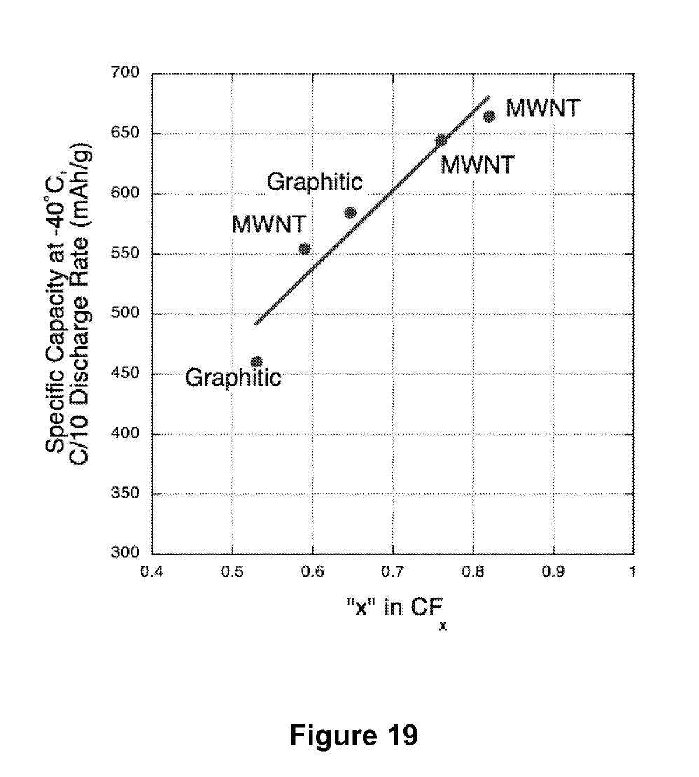

The type of graphitic precursor used did not have a significant impact on test cell performance at low temperatures. The data in FIG. 16 indicate a roughly linear relationship between degree of fluorination and capacity, and there did not appear to be a strong correlation showing that either the graphitic or the MWNT materials offered more favorable low temperature performance. This result is not entirely unexpected, as x-ray diffraction and electron microscopy results indicate a similar microstructure in these two types of sub-fluorinated carbons. FIG. 19 shows this relationship more clearly. The degree of fluorination was the strongest indicator of the energy density, even at low-temperatures. Since the baseline CF_{1.08} delivered much lower capacity (less than 300 mAh/g) under these same conditions, there must be a point between x=0.82 and 1.08 where the low temperature efficacy of this cathode is substantially reduced, even when implemented with the better-performing electrolyte blend and anion receptor identified in this Example.

### SUMMARY

The results illustrate that the nano-scale intermixing of pristine graphitic domains and CF_{0.8} domains observed in SFCFₓ materials greatly enhance the specific capacity of these materials at low temperatures at aggressive rates. Electrolyte screening identified that blends consisting of 20/80 v/v % PC/DME with 1 M LiBF₄ offered superior low temperature performance compared to the baseline formulations, based on 1 M LiBF₄ in either 50/50 v/v % or 20/80 v/v % PC/DME. Three variations of SFCFₓ cathode materials were inserted into similar ˜40 μm thick composite electrode structures and tested at −40° C. using several different electrolyte blends. The CF_{0.65} and CF_{0.82} based cells could deliver well over 600 mAh/g above 2 V under a C/5 discharge rate at −40° C. with the proper electrolyte blend. To further increase rate capability and/or functional cathode thickness, an anion receptor electrolyte additive, TTFEB, was evaluated and proved to be effective. With this additive, composite cathode structures 115 μm thick yielded over 500 mAh/g at a C/5 discharge rate at −40° C. These results indicate that both the CF/electrolyte interfacial area and the nature of any SEI that may form on these active areas are important to low temperature performance. In particular, the results indicate that this film was reaction-limiting early in the discharge process and could be mitigated by both lowering the electrolyte salt content and adding a LiF solvating agent. These modifications resulted in a greatly enhanced low temperature performance for this electrochemical couple, and have enabled cells that are functional to temperatures to −60° C. and possibly colder.

### Example 3

### Low Temperature Primary Li—CFₓ Battery Development and Testing

CFx Cathode Materials Development

Five variations of sub-fluorinated CFₓ cathode materials were examined and compared to commercially available CF₁ in the present Example. The main focus of these studies was to improve low temperature functionality of this class of materials by matching the sub-fluorinated cathode with the proper electrolyte blend. Test cells based on commercially-supplied CF_{1.08} powders were tested in parallel in identical test fixtures.

In the Example, the generation I and II materials consisted of partially fluorinated graphite, where x=0.53, and 0.65 respectively. The generation III material was partially fluorinated carbon nano-tube material (precursor supplied by MER corporation), where x was equal to 0.59, 0.76 and 0.82. In qualifying these different cathodes, a standard test vehicle was adopted that consisted of a spray—deposited cathode layer containing 10% PVDF binder, 10% carbon black conductive diluent, and 80% active material on a 1-mil thick Al current collector. These composite cathodes ranged in thickness from 10 μm to 120 μm, with the most commonly tested thickness being about 35 μm. The standard test cell consisted of 2032 coin cells with a Li metal anode, and a Tonen™ separator.

Many electrolyte variations were examined through the course of this Example.

Materials Characterization

The characterization data indicate that the SFCFₓ materials were comprised of pristine un-fluorinated graphite mixed intimately with fluorinated C. The SEM/XEDS analyses indicate that the C and F are intermixed at a very fine scale (at least smaller than 10's of nm), while the XRD data show that the graphitic material that has undergone fluorination is likely fluorinated to the same degree regardless of the total fluorination of the sample (i.e. x in CFₓ). There is also no evidence of graphitic gallery staging at the various levels of fluorination. The combination of these indicators suggests that the microstructure of this material is a collection of nano-dimensional graphite and CF_{y} domains, where y is approximately 0.8 to 0.9. The small scale of these compositionally variant regions dictates that the material have a very high graphite-to-CF_{y} surface area and subsequently will posses excellent electronic/interface transport properties at all temperatures.

Although thermodynamically predictable, the fluorination of graphite is kinetically unfavorable as it requires the following: i) separation of the graphene layers to allow for fluorine diffusion, ii) change in the carbon hybridization from stable sp² to less stable sp^{3,} and iii) dissociation of the F₂ molecule. At constant temperature and fluorine pressure, the chemical activity of fluorine decreases with the depth of fluorine penetration within the layers. Consequently, the rate of the fluorination reaction (C+y/2F₂=CF_{y}) should decrease as the diffusion layer becomes thicker, which eventually leads to an equilibrium state in which possibly a fraction of carbon remains unreacted. At 375 and 390° C. used to prepare CF_{0.54} and CF_{0.64} samples respectively, under 1 atmosphere fluorine pressure, the practical end point is reached after 17-hours reaction. Both samples show unreacted graphite.

Electrochemical Performance

Table 3 has a summary of some early test results taken from cells using the 1 M LiBF₄ salt content electrolytes.

| | | | | Discharge | Cap. | Average | |
|---|---|---|---|---|---|---|---|
| Cathode | Thickness | | Temp | Rate | (mAh/g) | Potential (V) | Wh/kg |
| CF_{1.08} | <1 | mil | 20° C. | 2 C | 430 | 2.2 | 946 |
| With excess C | | | | | | | |
| CF_{1.08} | <1 | mil | 20° C. | C/2 | 510 | 2.4 | 1224 |
| With excess C | | | | | | | |
| CF_{1.08} | <1 | mil | −40° C. | C/20 | 75 | 1.6 | 120 |
| With excess C | | | | | | | |
| CF_{1.08} | <1 | mil | −40° C. | C/40 | 200 | 1.9 | 380 |
| With excess C | | | | | | | |
| CF_{0.53} | ˜1 | mils | 20° C. | C/5 | 510 | 2.5 | 1275 |
| CF_{0.53} | ˜1 | mils | 20° C. | 2 C | 390 | 2.5 | 975 |
| CF_{0.53} | ˜1 | mils | −40° C. | C/10 | 393 | 1.9 | 1127 |
| | | | | C/20 | +59 | 2.1 | +124 |
| | | | | | 443 | | 1251 |
| CF_{0.53} | ˜1 | mils | −40° C. | C/10 | 334 | 1.9 | 635 |
| | | | | C/20 | +109 | 2.1 | +228 |
| | | | | | 452 | | 663 |
| CF_{0.647} | ˜2-3 | mils | 20° C. | C/5 | 600 | 2.6 | 1560 |
| CF_{0.647} | ˜2-3 | mils | 20° C. | 2 C | 525 | 2.3 | 1207 |
| CF_{0.647} | ˜2-3 | mils | −40° C. | C/40 | 630 | 2.25 | 1417 |
| CF_{0.647} | ˜1 to 2 | mil | −40° C. | C/40 | 610 | 2.25 | 1372 |
| CF_{0.647} | ˜1 to 2 | mil | −40° C. | C/40 | 615 | 2.25 | 1383 |
| CF_{0.647} | ˜2-3 | mils | −40° C. | C/20 | 110 | 2.15 | 236 |
| | | | | C/40 | +510 | 2.25 | +1174 |
| | | | | | 620 | | 1410 |
| CF_{0.647} | ˜2-3 | mils | −40° C. | C/10 | 10 | 1.75 | 17 |
| | | | | C/20 | +570 | 2.25 | +1282 |
| | | | | | 580 | | 1299 |

It is clear from these data that very inconsistent discharge capacities were obtained from cell to cell at higher discharge rates, though the best of the cells had very promising performance.

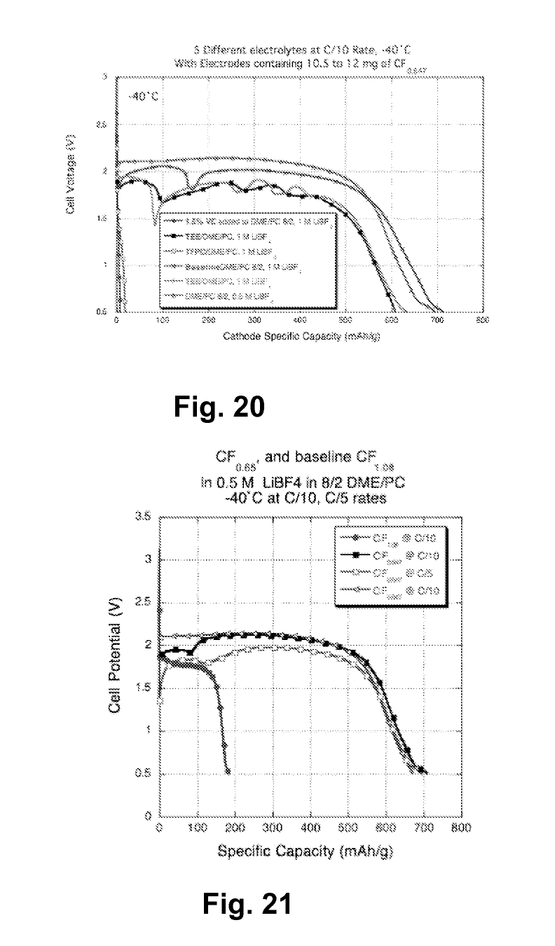

Promising new blend from the primary battery electrolyte sub-task were subsequently tested with these new cathodes and resulted in an important finding: a lower electrolytic salt content greatly enhanced the discharge stability and rate capability of the sub-fluorinated CFₓ materials at low temperatures. FIG. 20 shows a comparison of high rate (C/10) discharges of the generation II CF_{0.65} cathode material using different electrolytes. The 0.5 M LiBF₄ solvated in an 8/2 DME/PC blend had the most stable discharge while delivering over 600 mAh/g at −40° C. FIG. 21 shows the comparative performance of CF_{0.65} and CF_{1.08} at −40° C. at a C/10 and C/5 rate in this electrolyte blend. These results were repeatable and indicated several important findings: even with an optimized electrolyte blend, the sub-fluorinated CFₓ material out-performed the baseline material, and over 600 mAh/g could be obtained even at a C/5 discharge rate. Furthermore, the use of a room-temperature pre-discharge was not needed to enable low temperature functionality for these electrolytes.

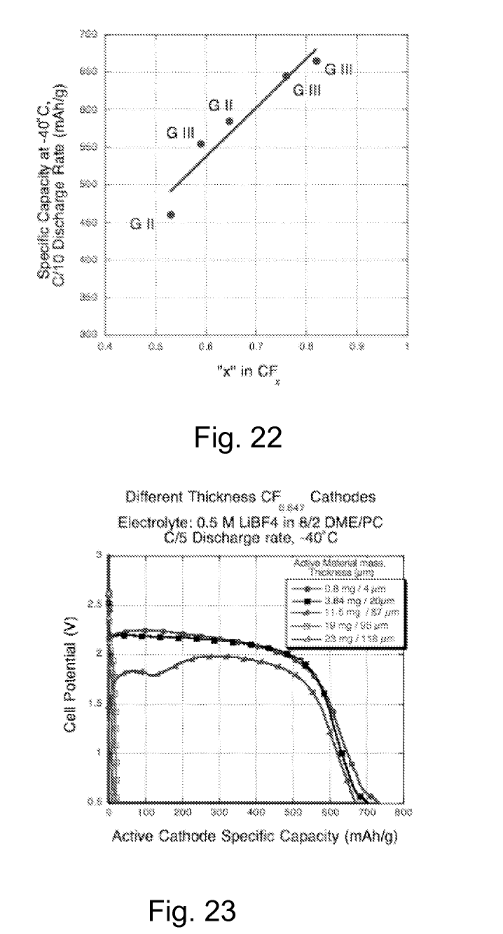

All of the new cathode materials were studied in this electrolyte blend under similar conditions and can therefore be directly compared. FIG. 22 shows a plot of delivered capacity at −40° C. at a C/10 rate for all five sub-fluorinated cathode materials. There was an essentially linear relationship between degree of fluorination and delivered capacity. Since the baseline cathode delivered less than 300 mAh/g under these same conditions, there is a point between x =0.82 and 1.08 where the low temperature efficacy of this cathode is substantially reduced.

A key factor that will dictate the practicality of implementing these new cathodes in industrially fabricated batteries for low temperature use is the nominal composite cathode thickness. This parameter has been found to be strongly correlated to CFₓ battery rate capability at room temperature and was therefore studied here. FIG. 23 shows the behavior of CF_{0.65} composite cathodes with thickness varying in thickness from 4 to 118 μm at a very aggressive C/5 discharge rate. The cells delivered full capacity with some polarization up to a thickness of at least 57 μm. Cathodes thicker than 95 μm polarized upon discharge (these cells were able to deliver full capacity at a C/10 rate for the 95 μm cathode and C/40 for the 120 μm thick cathode).

To establish that this uniquely structured material offers benefits compared to state-of-the-art (CF)ₙ cathode materials, it was necessary to create a control cathode based on commercially available CF_{1.08} that had the same fraction of fluorine in the as-tested cathode structure. Relatively large quantities of C black were used to lower the total F content in these cathodes to the same level as found in the CF_{0.54}-based cathodes (which used 10 wt % carbon black). At room temperatures, there was little difference between the SFCFₓ material and the industry baseline. Though the CF_{0.54} material had a higher potential initially, this material had a discharge plateau that was more sloping, and actually delivered less capacity at room temperature than the CF_{1.08} cathodes. This result is not unexpected, as the very thin cathode form factor used in these cells likely minimized the beneficial effects of the enhanced conductivity found in the SFCFₓ materials. It is possible that substantially thicker cathode structures would allow for the difference in performance between the CF_{1.08} and the CF_{0.54} to be resolved.

At −40° C., however, the commercial CF_{1.08} baseline and SFCFₓ cathode materials behaved differently. In particular, the CF_{1.08} yielded significantly lower capacities at lower discharge potentials than the SFCFₓ materials, even though the latter were in a slightly thicker electrode form factor, as summarized in Table 3. The CF_{1.08}-based cathodes typically delivered one-third the capacity of the CF_{0.65} material under identical conditions. The result is more pronounced when considering the fact that the baseline material cathodes also polarized to a greater degree, thereby offering a energy density.

This result indicates that the nano-scale intermixing of graphitic and CF_{y} materials is important for low-temperature performance, and cannot be emulated by physically mixing high surface area carbon materials with CF_{1.08} as which was shown to be sufficient for higher temperature testing environments. The two main differentiating features of the SFCFₓ material compared to the CF_{1.08} were (1) higher surface-area-to-mass ratio for the active CF_{y} domains, and (2) the existence of nano-scale electronically conductive pathways.

Anion Receptor Electrolyte Additive For Enhanced Rate Capability

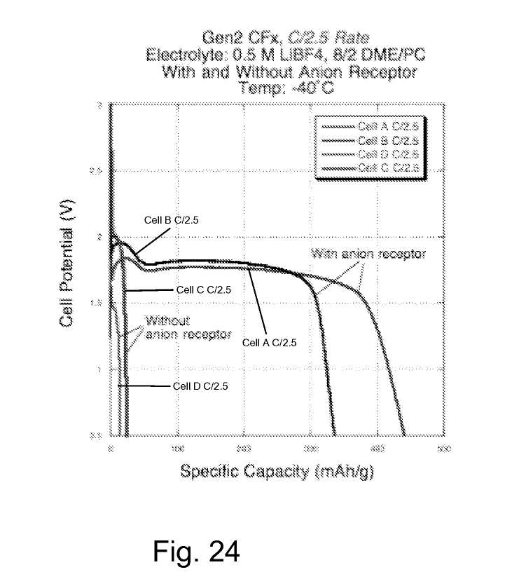

To further extend the low temperature performance, the possibility of using an anion receptor additive that might serve to solvate and remove excess inert LiF (discharge reaction product) from the electrode surface to allow for subsequent reaction has been examined. Specifically, we have found that tris-(2,2,2trifluoroethyl) borate, with relatively low molecular weight and viscosity, results in enhanced cell performance. This effect was observed when using sub-fluorinated CFₓ material. The difference in performance with and without the electrolyte additive was significant. For example, at −40° C., cells without the anion receptor additive were discharged at a rate of C/2.5, and were essentially nonfunctional. However, the same experiment repeated with cells incorporating 0.64 M tris (2,2,2 trifluoroethy) borate demonstrated that these cells were able to achieve nearly 50% of the room temperature capacity. FIG. 24 shows this comparison.

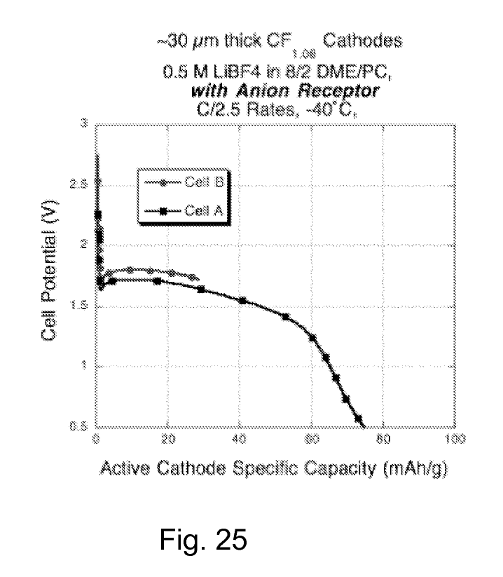

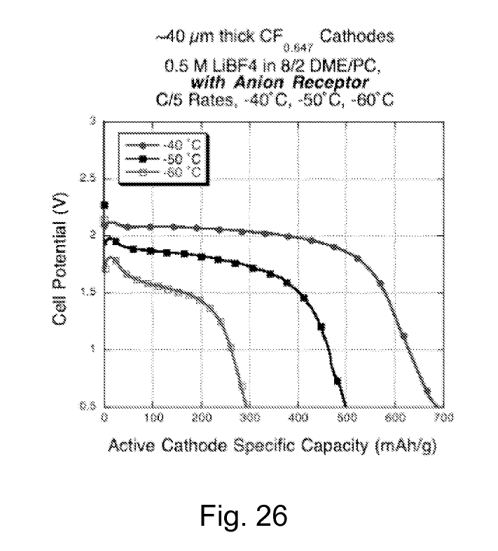

It is important to note that, in the limited testing performed using this additive, the improved performance was observed only when using the sub-fluorinated cathode materials: a total capacity of only 70 mAh/g was extracted from CF_{1.08}-based cathodes under identical conditions (C/2.5 rate, −40° C.) using the same electrolyte+anion receptor, as shown in FIG. 25. The performance of anion-receptor containing cells to temperatures as cold as −60° C. is shown in FIG. 26. These data show that, even at −60° C., nearly 300 mAh/g can be delivered at a C/5 discharge rate.

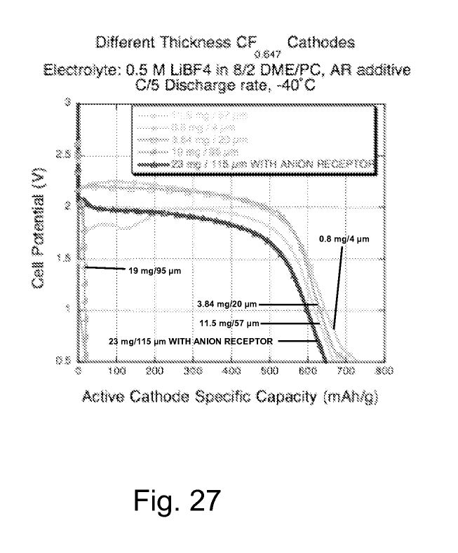

Another key advantage to using this anion receptor is extending the practical thickness of the composite cathodes. Discharges on test cells containing 115 μm thick cathode structures showed that the anion-receptor additive enabled high (C/5) discharge rate without any voltage delay or severe polarization effects. This cathode thickness exceeds that typically found in industrial Li-ion batteries and so shows that it is, in principle, possible to make a practical, high energy density CFₓ battery that is functional to very low temperatures. FIG. 27 provides a data for a thick electrode CF_{0.65} discharge with anion receptor additive: a functional, high rate (C/5) cathode 115 microns thick was created and offered nearly 600 mAh/g.

Summary of CFx Primary Battery Cathode Results

This Example shows that the nano-scale intermixing of graphitic domains and CF_{y} found in sub-fluorinated CFₓ (SFCFₓ) materials greatly benefited the specific capacity of these materials when discharged at low temperatures using aggressive current densities. The performance of SFCFₓ materials was compared to industry-standard, fully-fluorinated CF_{1.08} powders inserted in otherwise identical test cells. The SFCFₓ and CF_{1.08} active material yielded nearly the same specific capacity values at room temperature at rates as high as 2 C. However the SFCFₓ gave a 3 times (or greater) capacity value at −40° C. using rates up to C/10. The results also indicate that a room-temperature pre-discharge is important to low-temperature performance, an effect attributed to the kinetically-motivated cathode depassivation/conditioning events that occur upon initial discharge. It is suggested that the pre-discharge results in the evolution of a fluorine-free C layer at the electrode/electrolyte interface that would subsequently enhance electrolyte wetability and conductivity. These results show that the high specific capacity SFCF_{X} cathode chemistry is a viable intermediate rate low-temperature battery cathode material if prepared in a sub-fluorinated state and implemented in a sufficiently thin-electrode cell design.

Five variations of sub-fluorinated CFₓ cathode materials were tested at temperatures as cold as −60° C. using several different electrolyte variations. Multiple cells were examined for each materials combination, and different discharge currents were examined. With the proper electrolyte blend, 0.5 M LiBF₄ in 20/80 PC/DME, the best of these materials could deliver up to 600 mAh/g at a C/5 rate. To further increase rate capability and/or functional cathode thickness, an anion receptor electrolyte additive was evaluated and proved be effective. Using this electrolyte blend and a 115 μm thick CF_{0.65}-based cathode, a cell was fabricated that could deliver about 600 mAh/g at a C/5 rate.

The capacity/energy density of a D-sized cell produced using the CF_{0.647} cathode material can now be estimated (for a −40° C., C/5 discharge condition). It is assumed that the CF_{0.647} active material may be inserted into the same cell structure the 15.5 Ah D-size LiCFₓ battery under development at Eagle Picher. Substituting 600 mAh/g CF_{0.647} into this cell format results in a cell with an energy density of about 400 Wh/kg when discharged at a C/5 rate at −40° C. Approximately 120 μm thick composite cathodes containing CF_{0.7} combined with a Li metal anode in a 0.5 M LiBF₄ 8/2 DME/PC electrolyte with the tris-(2,2,2 trifluoroethyl) borate anion receptor additive offers excellent low temperature performance.

### Example 4

### Fluoride Ion Receptors for Electrolyte Compositions

The present invention includes nonaqueous electrolyte compositions having anion receptor additives useful in lithium batteries. Anion receptors in some aspects of the present invention are capable of conditioning the surfaces of subfluorinated and fully fluorinated carbonaceous positive electrode active materials by dissolving discharge products, such as LiF, that can degrade the electrical and ion conductivity at the electrode. To demonstrate this attribute, the capability of anion receptors of the present invention to coordinate fluoride ions in propylene carbonate solvent was evaluated.

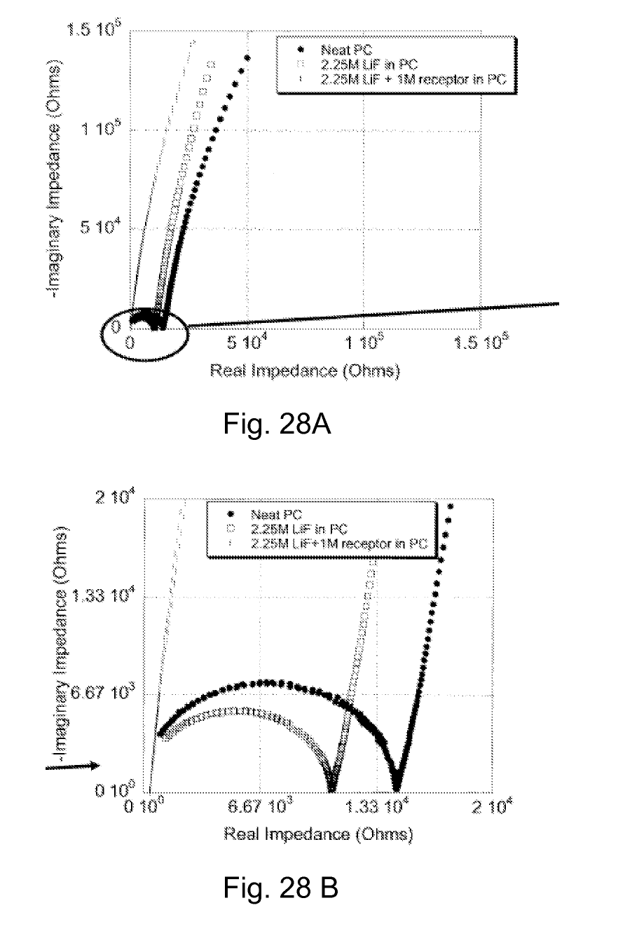

FIG. 28A provides plots of the imaginary impedance (Ohms) versus real impedance (Ohms) for propylene carbonate solvent having a varying lithium salt and anion receptor composition. FIG. 28B shows these plots on an expanded scale for the circled region indicated in FIG. 28A. In plots 28A and 28B, circle markers correspond to pure propylene carbonate solvent, open square markers correspond to 2.25 M LiF in propylene carbonate solvent, and dashed line markers correspond to 2.25 M LiF, 1 M tris (hexafluoroisopropyl) borate anion receptor in propylene carbonate solvent. The test setup employed in these experiments was a Pt-Pt conductivity cell at room temperature.

As shown in FIGS. 28A and 28B, pure propylene carbonate solvent and 2.25 M LiF in propylene carbonate solvent exhibit very low conductivity on the order of about 0.01 mS cm⁻¹. In contrast, conditions of 2.25 M LiF,1 M tris (hexafluoroisopropyl) borate in propylene carbonate solvent show greatly enhanced conductivity on the order of about 0.39 mS cm⁻¹. The enhancement of the conductivity observed upon the addition of tris (hexafluoroisopropyl) borate is due to the conductivity of Li⁺ and F⁻¹ ions formed upon dissolution of LiF. These results demonstrate that tris (hexafluoroisopropyl) borate is an effective fluoride ion anion receptor capable of dissolving LiF in propylene carbonate solvent.

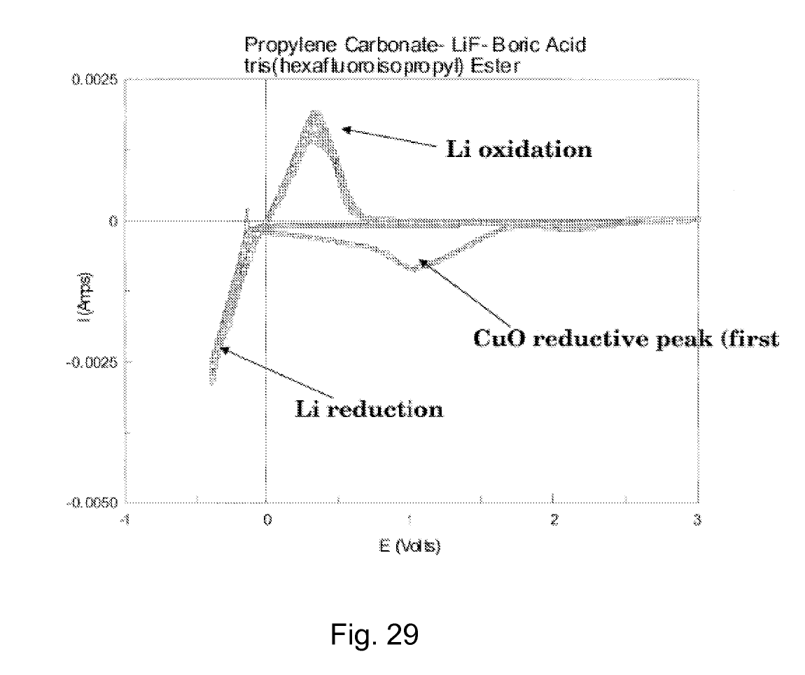

FIG. 29 provides plots showing the results of cyclic voltammetry experiments which show the reductive stability of a tris (hexafluoroisopropyl) borate anion receptor in a propylene carbonate solvent. Experimental conditions corresponding to FIG. 29 are a saturated solution of 1:1 (molar ratio) LiF:tris (hexafluoroisopropyl) borate (THFIPB) in propylene carbonate. To probe the reductive stability of the electrolyte solutions, a Cu working electrode was driven to negative potentials vs. Li/Li⁺, and then the potential sweep was reversed to induce positive potentials. Provided the electrolyte solution was reductively stable to Li, then Li metal should be stripped from the Li counter electrode and plated on the Cu working electrode when the potential of the working electrode falls below OV vs. Li/Li⁺. As the voltage sweep is reversed and the potential at the working electrode rises above OV vs. Li/Li⁺, any plated Li on the Cu working electrode should be stripped and re-plated at the Li counter. If, however, the electrolyte is not stable in contact with Li metal, then the small amount of plated Li metal at the Cu working electrode will react with the electrolyte and will not be stripped from the Cu working electrode. In this manner, it is possible to probe the relative stability of the electrolytes to Li metal. For the LiF-PC-THFIPB solution a sharp negative spike in current was observed as the voltage became negative relative to the Li counter (FIG. 29). When the potential sweep was reversed and the Cu working electrode was polarized positive relative to the Li counter electrode, a well defined anodic current peak was observed and attributed to Li stripping at the Cu working electrode for the LiF-PC-THFIPB solution. It is concluded that the PC based electrolytes when coupled with THFIPB and LiF had appropriate reductive stability against Li plating and stripping.

The plots in FIG. 29 indicate that LiF can be repeatedly plated out on (i.e., deposited) and stripped from the electrode. This observation shows that tris (hexafluoroisopropyl) borate anion receptor is reductively stable at the anode under these experimental conditions, and, thus, has a chemical stability useful for its incorporation in lithium battery systems.

Furthermore, fluoride ion anion receptors of the present invention, such as tris (hexafluoroisopropyl) borate, decrease electrolyte viscosity and improve low temperature conductivity. The present anion receptors complex BF₄⁻¹, thereby increase the Li⁺ transport number in electrolyte systems having a LiBF₄ lithium salt.

### REFERENCES

Bruce, G. Development of a CFx D Cell for Man Portable Applications. in Joint Service Power Expo. 2005.
Gabano, J. P., ed. Lithium Batteries, by M. Fukuda & T. lijima. 1983, Academic Press: New York.
Linden, D. and T. B. Reddy, Handbook of Batteries. 3rd ed. 2001, New York: McGraw Hill.
Gunther, R. G. in Fifth Power Sources Conference. Pages 713-728, 1975.
T. Tan, P. Lam, and H. Yumoto. Li/(CF)n Battery for Low Temperature and High Power Application. in 208th Electrochemical Society Meeting. 2005. Los Angeles, Calif.
Rohde, D., M. J. Root, and D. Fostor. Li/CFx Cell and Material Development for High Rate Applications. in 37th Power Sources Conference. 1996.
Hany, P., R. Yazami, and A. Hamwi. Journal of Power Sources, 1997. 68(2): p. 708-710.
Lam, P. and R. Yazami. Journal of Power Sources, 2005.
Kita, Y., Watanabe, N., and Fujii, Y., J. Am. Chem. Soc. 1979, 101(14), 3832-3841.
Walsh, F., M. Pozin, and J. K. Tikhonov. Storage of Li/CFx Cells. in 38th Power Sources Conference. 1998.
Whitacre et. al., to be published, 2006
Lam, P. and R. Yazami, Journal of Power Sources, 153(2) p. 354-359, (2006).
Whitacre, J. F., Yazami, R., Hamwi, A., Smart, M. C., W. Bennett, G. K. S. Prakash, Miller, T., Bugga, R. V. Journal of Power Sources, 160: p. 577-584, (2006).
Guerin, K., Yazami, R., Hamwi, A., Electrochemical and Solid State letters, 7(6) p. A159-A162, (2004).
Lee, H. S., et al., Journal of the Electrochemical Society 151(9): p. A1429-A1435, (2004).
Sun, X. H., et al., Electrochemical and Solid State Letters 6(2): p. A43-A46, (2003).
Sun, X., et al., Electrochemical and Solid State Letters 1(6): p. 239-240, (1998).
M. Fukuda, T. I. Li/CFx Cylindrical Type Batteries. in Fifth Power Sources Conference (1975).
Gunther, R. G. Factors Influencing the Performance of Li—CFx Organic Electrolyte Batteries. in Fifth Power Sources Conference (1975).
Ding M. S., Xu K., Zhang S. S., Amine K., Henriksen G. L., Jow T. R., J. Electrochem. Soc. 148(10):p. A1196-A1204, (2001).

### Statements Regarding Incorporation by Reference and Variations

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

When a group of substituents is disclosed herein, it is understood that all individual members of that group and all subgroups, including any isomers, enantiomers, and diastereomers of the group members, are disclosed separately. When a Markush group or other grouping is used herein, all individual members of the group and all combinations and subcombinations possible of the group are intended to be individually included in the disclosure. When a compound is described herein such that a particular isomer, enantiomer or diastereomer of the compound is not specified, for example, in a formula or in a chemical name, that description is intended to include each isomers and enantiomer of the compound described individual or in any combination. Additionally, unless otherwise specified, all isotopic variants of compounds disclosed herein are intended to be encompassed by the disclosure. For example, it will be understood that any one or more hydrogens in a molecule disclosed can be replaced with deuterium or tritium. Isotopic variants of a molecule are generally useful as standards in assays for the molecule and in chemical and biological research related to the molecule or its use. Methods for making such isotopic variants are known in the art. Specific names of compounds are intended to be exemplary, as it is known that one of ordinary skill in the art can name the same compounds differently.

Many of the molecules disclosed herein contain one or more ionizable groups [groups from which a proton can be removed (e.g., —COOH) or added (e.g., amines) or which can be quaternized (e.g., amines)]. All possible ionic forms of such molecules and salts thereof are intended to be included individually in the disclosure herein. With regard to salts of the compounds herein, one of ordinary skill in the art can select from among a wide variety of available counterions those that are appropriate for preparation of salts of this invention for a given application. In specific applications, the selection of a given anion or cation for preparation of a salt may result in increased or decreased solubility of that salt.

Every formulation or combination of components described or exemplified herein can be used to practice the invention, unless otherwise stated.

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter are claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

We claim:

1. An electrochemical cell capable of low temperature operation comprising:
a positive electrode comprising a subfluorinated carbonaceous material having an average stoichiometry CFₓ, wherein x is the average atomic ratio of fluorine atoms to carbon atoms and is selected from the range of about 0.3 to about 1.0; said subfluorinated carbonaceous material being a multiphase material having an unfluorinated carbon component;
a negative electrode; and
a nonaquoues electrolyte provided between said positive and negative electrodes.

2. The electrochemical cell of claim 1 wherein said carbonaceous material is selected from the group consisting of graphite, coke, multiwalled carbon nanotubes, multi-layered carbon nanofibers, multi-layered carbon nanoparticles, carbon nanowhiskers and carbon nanorods.

3. The electrochemical cell of claim 1 wherein x is selected from the range of about 0.50 to about 0.85.

4. The electrochemical cell of claim 1 wherein said unfluorinated carbon component is between about 5% to about 70% by mass of said subfluorinated carbonaceous material.

5. The electrochemical cell of claim 1 wherein said unfluorinated carbon component is between about 10% to about 20% by mass of said subfluorinated carbonaceous material.

6. The electrochemical cell of claim 1 wherein said subfluorinated carbonaceous material comprises nanostructured particles; wherein each of said nanostructured particles comprise a plurality of fluorinated domains and a plurality of unfluorinated domains.

7. The electrochemical cell of claim 6 wherein said fluorinated domains of said nanostructured particles have an average stoichiometry CF_{y}, wherein y is the average atomic ratio of fluorine atoms to carbon atoms and is selected from the range of about 0.8 to about 0.9.

8. The electrochemical cell of claim 6 wherein said unfluorinated domains of said nanostructured particles is a unfluorinated carbonaceous material selected from the group consisting of graphite, coke, multiwalled carbon nanotubes, multi-layered carbon nanofibers, multi-layered carbon nanoparticles, carbon nanowhiskers and carbon nanorods

9. The electrochemical cell of claim 6 wherein said fluorinated and unfluorinated domains have physical dimensions less than about 50 nanometers.

10. The electrochemical cell of claim 6 wherein said fluorinated domains and said unfluorinated domains are substantially uniformly distributed throughout said nanostructured particles.

11. The electrochemical cell of claim 1 wherein said positive electrode further comprises a conductive diluent and a binder.

12. The electrochemical cell of claim 11 wherein the conductive diluent is one or more materials selected from the group consisting of acetylene black, carbon black, powdered graphite, coke, carbon fiber, and metallic powder.

13. The electrochemical cell of claim 11 wherein the binder is a polymer.

14. The electrochemical cell of claim 13 wherein the binder is a fluoropolymer.

15. The electrochemical cell of claim 1 wherein said negative electrode comprises a source of ions of a metal selected from Groups 1, 2, and 3 of the Periodic Table of Elements.

16. The electrochemical cell of claim 15 wherein said negative electrode comprises a source of lithium ions.

17. The electrochemical cell of claim 16 wherein the source of lithium ions is selected from the group consisting of lithium metal, a lithium alloy, and a carbon-lithium material.

18. The electrochemical cell of claim 1 wherein said nonaqueous electrolyte is a nonaqueous electrolyte solution, wherein said nonaqueous electrolyte solution comprises a lithium salt and a solvent.

19. The electrochemical cell of claim 18 wherein said lithium salt is selected from the group consisting of LiBF₄, LiF, LiCIO₄, LiAsF₆, LiSbF₆ and LiPF₆.

20. The electrochemical cell of claim 18 wherein said lithium salt has a concentration in said nonaqueous electrolyte solution less than 1.0 M.

21. The electrochemical cell of claim 18 wherein said lithium salt has a concentration in said nonaqueous electrolyte solution selected from the range of about 0.75 M to about 0.25 M.

22. The electrochemical cell of claim 18 wherein said solvent comprises one or more materials selected from group consisting of propylene carbonate, 1,2-dimethoxy ethane, trifluoroethyl ether, diethyl ether, diethoxyethane, 1,3 -dioxolane, tetrahydrofuran, 2-methyl-THF, ethylene carbonate, dimethyl carbonate, diethyl carbonate, ethyl methyl carbonate, methyl formate, α-butyrolactone, methylacetate, and any fluorine analogs thereof.

23. The electrochemical cell of claim 18 wherein said solvent comprises a mixture of propylene carbonate and 1,2-dimethoxy ethane wherein said solvent has a volume to volume ratio of propylene carbonate to 1,2-dimethoxy ethane is selected from the range of about 0.25 to about 1.

24. The electrochemical cell of claim 18 wherein said solvent further comprises an ether having at least one fluroalkyl group.

25. The electrochemical cell of claim 24 wherein the ether having at least one fluroalkyl group is trifluoroethyl ether.

26. The electrochemical cell of claim 24 wherein said ether having at least one fluroalkyl group of said solvent has a percent by volume of the solvent selected from the range of about 10% to about 40%.

27. The electrochemical cell of claim 18 wherein said nonaqueous electrolyte solution further comprises an anion receptor.

28. The electrochemical cell of claim 28 wherein said anion receptor is a fluoride ion anion receptor.

29. The electrochemical cell of claim 28 wherein said anion receptor binds to fluoride ion; wherein said anion receptor is capable of dissolving at least in part a layer of LiF generated upon discharge of said electrochemical cell.

30. The electrochemical cell of claim 28 wherein said anion receptor has the chemical structure: 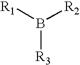
wherein R₁, R₂ and R₃ are independently selected from the group consisting of alkyl, aromatic, ether, thioether, heterocyclic, aryl or heteroaryl groups which are optionally substituted with one or more halogens, including F, alkyl, alkoxide, thiol, thioalkoxide, aromatic, ether or thioether.

31. The electrochemical cell of claim 28 wherein said anion receptor has the chemical structure: 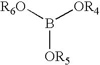
wherein R₄, R₅ and R₆ are selected from the group consisting of alkyl, aromatic, heterocyclic, aryl or heteroaryl groups which are optionally substituted with one or more halogens, including F, alkyl, alkoxide, thiol, thioalkoxide, aromatic, ether or thioether.

32. The electrochemical cell of claim 28 wherein said anion receptor has a chemical structure selected from the group consisting of:

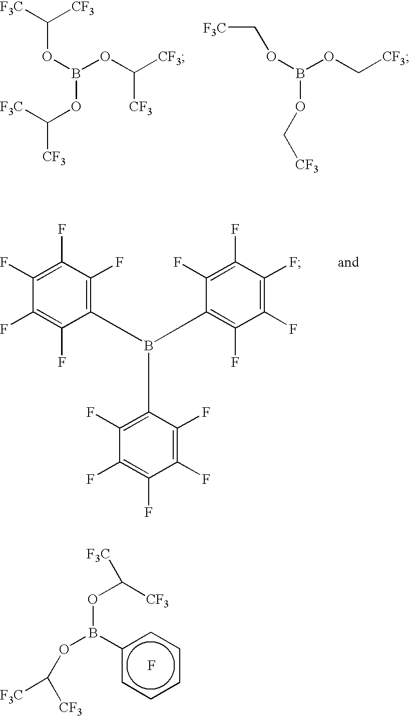

33. The electrochemical cell of claim 28 wherein said anion receptor has a formula selected from the group consisting of: (CH₃O)₃B, (CF₃CH₂O)₃B, (C₃F₇CH₂O)₃B, [(CF₃)₂CHO]₃B, [(CF₃)₂C(C₆H₅)O]₃B, ((CF₃)CO)₃B, (C₆H₅O)₃B, (FC₆H₄O)₃B, (F₂C₆H₃O)₃B, (F₄C₆HO)₃B,(C₆F₅O)₃B, (CF₃C₆H₄O) ₃B, (C₆F₅)₃B.

34. The electrochemical cell of claim 28 wherein said anion receptor has a concentration in said nonaqueous electrolyte solution less than 2 M.

35. The electrochemical cell of claim 1 capable of providing discharge rates equal to or greater than C/5 at temperatures lower than or equal to −40 degrees Celsius; wherein C is the capacity of the electrochemical cell.

36. The electrochemical cell of claim 1 capable of providing a specific capacity equal to or greater than 625 mAh g⁻¹ at a discharge rate equal to or greater than C/40 and with a discharge voltage greater than or equal to about 2V at a temperature equal to −40 degrees Celsius.

37. A lithium battery capable of low temperature operation comprising:
a positive electrode comprising a subfluorinated carbonaceous material having an average stoichiometry CFₓ, wherein x is the average atomic ratio of fluorine atoms to carbon atoms and is selected from the range of about 0.3 to about 1.0;
said subfluorinated carbonaceous material being a multiphase material having an unfluorinated carbon component;
a negative electrode comprising a source of lithium ions; and
a nonaquoues electrolyte solution provided between said positive and negative electrodes; said nonaquoues electrolyte solution comprising a lithium salt, a solvent and a fluoride ion anion receptor.

38. The lithium battery of claim 37 wherein said carbonaceous material is selected from the group consisting of graphite, coke, multiwalled carbon nanotubes, multi-layered carbon nanofibers, multi-layered carbon nanoparticles, carbon nanowhiskers and carbon nanorods; and wherein x is selected from the range of about 0.50 to about 0.9.

39. The lithium battery of claim 37 wherein said unfluorinated carbon component is between about 5% to about 70% by mass of said subfluorinated carbonaceous material.

40. The lithium battery of claim 37 wherein said unfluorinated carbon component is between about 10% to about 20% by mass of said subfluorinated carbonaceous material.

41. The lithium battery of claim 37 wherein said lithium salt is LiBF₄ and has a concentration in said nonaqueous electrolyte solution less than or equal to about 0.5 M.

42. The lithium battery of claim 37 wherein said solvent comprises a mixture of propylene carbonate and 1,2-dimethoxy ethane; and wherein said solvent has a volume to volume ratio of propylene carbonate to 1,2-dimethoxy ethane that is less than about about 0.5.

43. The lithium battery of claim 37 wherein said fluoride ion anion receptor binds to fluoride ion; wherein said anion receptor is capable of dissolving at least in part a layer of LiF generated upon discharge of said electrochemical cell.

44. The lithium battery of claim 37 wherein said fluoride ion anion receptor has the chemical structure: 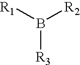
wherein R₁, R₂ and R₃ are independently selected from the group consisting of alkyl, aromatic, ether, thioether, heterocyclic, aryl or heteroaryl groups which are optionally substituted with one or more halogens, including F, alkyl, alkoxide, thiol, thioalkoxide, aromatic, ether or thioether.

45. The lithium battery of claim 37 wherein said fluoride ion anion receptor has the chemical structure: 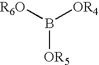
wherein R₄, R₅ and R₆ are selected from the group consisting of alkyl, aromatic, heterocyclic, aryl or heteroaryl groups which are optionally substituted with one or more halogens, including F, alkyl, alkoxide, thiol, thioalkoxide, aromatic, ether or thioether.

46. The lithium battery of claim 37 wherein said fluoride ion anion receptor has a chemical structure selected from the group consisting of:

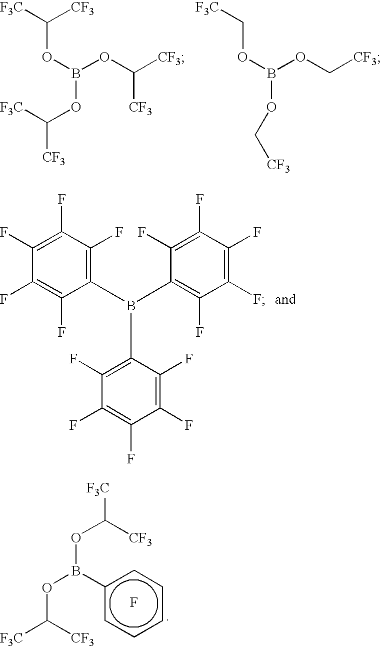

47. The lithium battery of claim 37 wherein said fluoride ion anion receptor has a formula selected from the group consisting of: (CH₃O)₃B, (CF₃CH₂O)₃B, (C₃F₇CH₂O)₃B, [(CF₃)₂CHO]₃B, [(CF₃)₂C(C₆H₅) O]₃B, ((CF₃)CO₃B, (C₆H₅O)₃B, (FC₆H₄O)₃B, (F₂C₆H₃O)₃B, (F₄C₆HO)₃B,(C₆F₅O) ₃B,(CF₃C₆H₄O)₃B, [(CF₃)₂C₆H₃O]₃B and (C₆F₅)₃B.

48. The lithium battery of claim 37 wherein said fluoride ion anion receptor has a concentration in said nonaqueous electrolyte less than about 2 M.
